(19) United States
(12) Patent Application Publication
(10) Pub. No.: US 2025/0014264 A1
(43) Pub. Date: Jan. 9, 2025

(54) IMAGE PROCESSING APPARATUS, IMAGE PROCESSING METHOD, AND IMAGE PROCESSING PROGRAM

(71) Applicant: FUJIFILM Corporation, Tokyo (JP)

(72) Inventor: Toshihiro OOGUNI, Saitama-shi (JP)

(73) Assignee: FUJIFILM Corporation, Tokyo (JP)

(21) Appl. No.: 18/888,651

(22) Filed: Sep. 18, 2024

Related U.S. Application Data
(63) Continuation of application No. PCT/JP2023/008099, filed on Mar. 3, 2023.

(30) Foreign Application Priority Data
Mar. 30, 2022 (JP) 2022-057497

(51) Int. Cl. G06T 15/20; H04N 5/74

(52) U.S. Cl. CPC G06T 15/20; H04N 5/74

(57) ABSTRACT

An image processing apparatus includes a processor configured to: acquire first image data obtained by imaging a space with an imaging apparatus; generate first virtual projection surface data representing a first virtual projection surface and first virtual projection apparatus data representing a first virtual projection apparatus, based on first position data representing a first position in the space and first normal vector data representing a first normal vector of a first surface corresponding to an object present at the first position in the space; generate second image data representing a second image in which the first virtual projection surface and the first virtual projection apparatus are displayed on a first image represented by the first image data, based on the first image data, the first virtual projection surface data, and the first virtual projection apparatus data; and output the second image data to an output destination.

### CROSS REFERENCE TO RELATED APPLICATION

This is a continuation of International Application No. PCT/JP2023/008099 filed on Mar. 3, 2023, and claims priority from Japanese Patent Application No. 2022-057497 filed on Mar. 30, 2022, the entire disclosures of which are incorporated herein by reference.

### BACKGROUND OF THE INVENTION

### 1. Field of the Invention

The present invention relates to an image processing apparatus, an image processing method, and a computer readable medium storing an image processing program.

### 2. Description of the Related Art

JP2018-005115A discloses a projection image adjustment system that stores virtual environment installation information indicating an installation state of a projector installed to obtain a desired image projection state onto a projection target object in a virtual space and control setting values of the projector at that time, acquires real environment installation information indicating an installation state of the projector in a real space, controls an operation of the projector, corrects the control setting values based on the virtual environment installation information and the real environment installation information to eliminate any difference between a projection state of an image in the real space and a desired image projection state, and controls the operation based on the corrected control setting values.

JP2017-073717A discloses an image processing apparatus that acquires relevant information related to a target object using a captured image obtained by imaging the target object, generates a relevant image generated from the relevant information, generates a superimposed image in which the relevant image is superimposed on the captured image containing the target object, and projects the generated superimposed image.

JP2013-235374A discloses an image processing apparatus that acquires an input image generated by imaging a real space using an imaging apparatus, outputs an output image for superimposing a virtual object associated with a real object shown in the input image to a projection apparatus, projects the output image onto the real object, and controls the projection of the output image by the projection apparatus based on a position of the real object recognized using the input image.

### SUMMARY OF THE INVENTION

One embodiment according to the technology of the present disclosure provides an image processing apparatus, an image processing method, and a computer readable medium storing an image processing program capable of improving a user convenience related to a disposition of a projection surface or a projection apparatus.

According to one aspect of the present invention, there is provided an image processing apparatus comprising a processor, in which the processor is configured to: acquire first image data obtained by imaging a space with an imaging apparatus; generate first virtual projection surface data representing a first virtual projection surface and first virtual projection apparatus data representing a first virtual projection apparatus, based on first position data representing a first position in the space and first normal vector data representing a first normal vector of a first surface corresponding to an object present at the first position in the space; generate second image data representing a second image in which the first virtual projection surface and the first virtual projection apparatus are displayed on a first image represented by the first image data, based on the first image data, the first virtual projection surface data, and the first virtual projection apparatus data; and output the second image data to an output destination.

According to another aspect of the present invention, there is provided an image processing method executed by a processor of an image processing apparatus, the image processing method comprising: acquiring first image data obtained by imaging a space with an imaging apparatus; generating first virtual projection surface data representing a first virtual projection surface and first virtual projection apparatus data representing a first virtual projection apparatus, based on first position data representing a first position in the space and first normal vector data representing a first normal vector of a first surface corresponding to an object present at the first position in the space; generating second image data representing a second image in which the first virtual projection surface and the first virtual projection apparatus are displayed on a first image represented by the first image data, based on the first image data, the first virtual projection surface data, and the first virtual projection apparatus data; and outputting the second image data to an output destination.

According to still another aspect of the present invention, there is provided an image processing program, stored in a computer readable medium, for causing a processor of an image processing apparatus to execute a process comprising: acquiring first image data obtained by imaging a space with an imaging apparatus; generating first virtual projection surface data representing a first virtual projection surface and first virtual projection apparatus data representing a first virtual projection apparatus, based on first position data representing a first position in the space and first normal vector data representing a first normal vector of a first surface corresponding to an object present at the first position in the space; generating second image data representing a second image in which the first virtual projection surface and the first virtual projection apparatus are displayed on a first image represented by the first image data, based on the first image data, the first virtual projection surface data, and the first virtual projection apparatus data; and outputting the second image data to an output destination.

According to the aspects of the present disclosure, it is possible to provide an image processing apparatus, an image processing method, and a computer readable medium storing an image processing program capable of improving a user convenience related to a disposition of a projection surface or a projection apparatus.

### BRIEF DESCRIPTION OF THE DRAWINGS

FIG. 1 is a schematic diagram showing an example of a projection apparatus 10 that is a target for installation support by an image processing apparatus according to Embodiment 1.

FIG. 2 is a schematic diagram showing an example of an internal configuration of a projection portion 1 shown in FIG. 1.

FIG. 3 is a schematic diagram showing an external configuration of the projection apparatus 10.

FIG. 4 is a schematic cross-sectional view of an optical unit 106 of the projection apparatus 10 shown in FIG. 3.

FIG. 5 is a diagram showing an example of an appearance of an image processing apparatus 50.

FIG. 6 is a diagram showing an example of a hardware configuration of the image processing apparatus 50.

FIG. 7 is a diagram showing an example of acquiring a posture of an imaging apparatus of the image processing apparatus 50.

FIG. 8 is a diagram showing an example of imaging a first image and acquiring a first position.

FIG. 9 is a diagram showing an example of a physical space image represented by first image data obtained by imaging a physical space 70.

FIG. 10 is a flowchart showing an example of processing of the image processing apparatus 50.

FIG. 11 is an example (part 1) of an image displayed by the image processing apparatus 50 in the processing shown in FIG. 10.

FIG. 12 is an example (part 2) of an image displayed by the image processing apparatus 50 in the processing shown in FIG. 10.

FIG. 13 is a diagram showing an example of detecting an end part of a physical plane in which a first virtual projection surface 111 is disposed in the physical space 70.

FIG. 14 is a flowchart showing an example of determination processing of a first position 81.

FIG. 15 is a diagram (part 1) showing an example of determining the first position 81 in the determination processing of FIG. 14.

FIG. 16 is a diagram (part 2) showing an example of determining the first position 81 in the determination processing of FIG. 14.

FIG. 17 is a flowchart showing an example of determination processing of a size of the first virtual projection surface 111.

FIG. 18 is a diagram (part 1) showing an example of determining the size of the first virtual projection surface 111 and the first position 81 in the determination processing of FIG. 17.

FIG. 19 is a diagram (part 2) showing an example of determining the size of the first virtual projection surface 111 and the first position 81 in the determination processing of FIG. 17.

FIG. 20 is a diagram (part 1) showing an example of an operation unit for moving the first virtual projection surface 111.

FIG. 21 is a diagram (part 2) showing an example of an operation unit for moving the first virtual projection surface 111.

FIG. 22 is a diagram (part 1) showing an example of an operation unit for changing an angle of the first virtual projection surface 111.

FIG. 23 is a diagram (part 2) showing an example of an operation unit for changing an angle of the first virtual projection surface 111.

FIG. 24 is a diagram showing an example of imaging a first image and acquiring first and second positions.

FIG. 25 is a diagram showing an example of a second virtual projection surface based on the second position.

FIG. 26 is a diagram showing an example of coordinate axes for movement of a first virtual projection apparatus 112.

FIG. 27 is a diagram (part 1) showing an example of an operation unit for moving the first virtual projection apparatus 112 in an x-axis direction or a z-axis direction.

FIG. 28 is a diagram (part 2) showing an example of an operation unit for moving the first virtual projection apparatus 112 in the x-axis direction or the z-axis direction.

FIG. 29 is a diagram (part 1) showing an example of an operation unit for moving the first virtual projection apparatus 112 in a y-axis direction.

FIG. 30 is a diagram (part 2) showing an example of an operation unit for moving the first virtual projection apparatus 112 in the y-axis direction.

FIG. 31 is a diagram showing an example of a physical curved surface on which a projection surface 11 is disposed in Embodiment 2.

FIG. 32 is a diagram showing an example of designating a second position group.

FIG. 33 is a diagram showing an example of a first virtual curved surface virtually showing a wall 310.

### DESCRIPTION OF THE PREFERRED EMBODIMENTS

An example of an embodiment of the present invention will be described below with reference to the drawings.

### Embodiment 1

<Example of Projection Apparatus 10 that is Target for Installation Support by Image Processing Apparatus According to Embodiment 1>

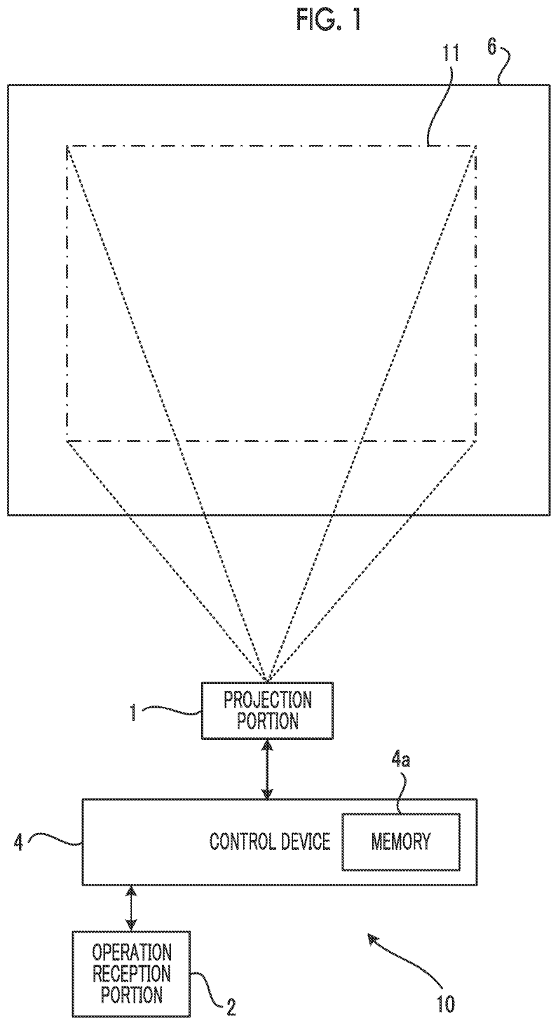

FIG. 1 is a schematic diagram showing an example of a projection apparatus 10 that is a target for installation support by an image processing apparatus according to Embodiment 1.

The image processing apparatus according to Embodiment 1 can be used, for example, to support disposition of the projection apparatus 10. The projection apparatus 10 comprises a projection portion 1, a control device 4, and an operation reception portion 2. The projection portion 1 is composed of, for example, a liquid crystal projector or a projector using liquid crystal on silicon (LCOS). In the following description, it is assumed that the projection portion 1 is a liquid crystal projector.

The control device 4 is a control device that controls projection performed by the projection apparatus 10. The control device 4 is a device including a control unit composed of various processors, a communication interface (not shown) for communicating with each portion, and a memory 4a such as a hard disk, a solid-state drive (SSD), or a read-only memory (ROM) and integrally controls the projection portion 1.

Examples of the various processors of the control unit of the control device 4 include a central processing unit (CPU) which is a general-purpose processor that executes a program to perform various functions, a programmable logic device (PLD) which is a processor capable of changing a circuit configuration after manufacture such as a field-programmable gate array (FPGA), a dedicated electrical circuit which is a processor having a circuit configuration exclusively designed to execute specific processing such as an application-specific integrated circuit (ASIC), or the like.

More specifically, a structure of these various processors is an electrical circuit in which circuit elements such as semiconductor elements are combined. The control unit of the control device 4 may be configured with one of the various processors or may be configured with a combination of two or more processors of the same type or different types (for example, a combination of a plurality of FPGAs or a combination of a CPU and an FPGA).

The operation reception portion 2 detects an instruction from a user by receiving various operations from the user. The operation reception portion 2 may be a button, a key, a joystick, or the like provided in the control device 4 or may be a reception portion or the like that receives a signal from a remote controller for remotely operating the control device 4.

A projection object 6 is an object such as a screen or a wall having a projection surface on which a projection image is displayed by the projection portion 1. In the example shown in FIG. 1, the projection surface of the projection object 6 is a rectangular plane. It is assumed that upper, lower, left, and right sides of the projection object 6 in FIG. 1 are upper, lower, left, and right sides of the actual projection object 6.

A projection surface 11 shown by a dot-dashed line is a region irradiated with projection light by the projection portion 1 in the projection object 6. In the example shown in FIG. 1, the projection surface 11 is rectangular. The projection surface 11 is a part or the entirety of a projectable range in which the projection can be performed by the projection portion 1.

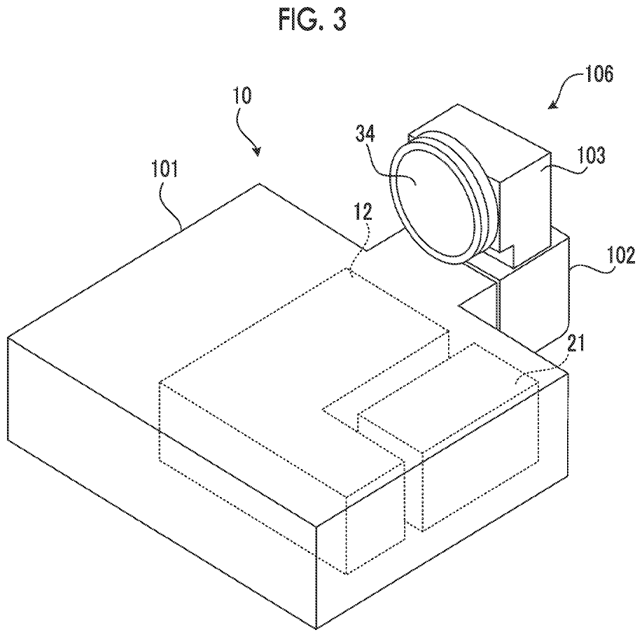

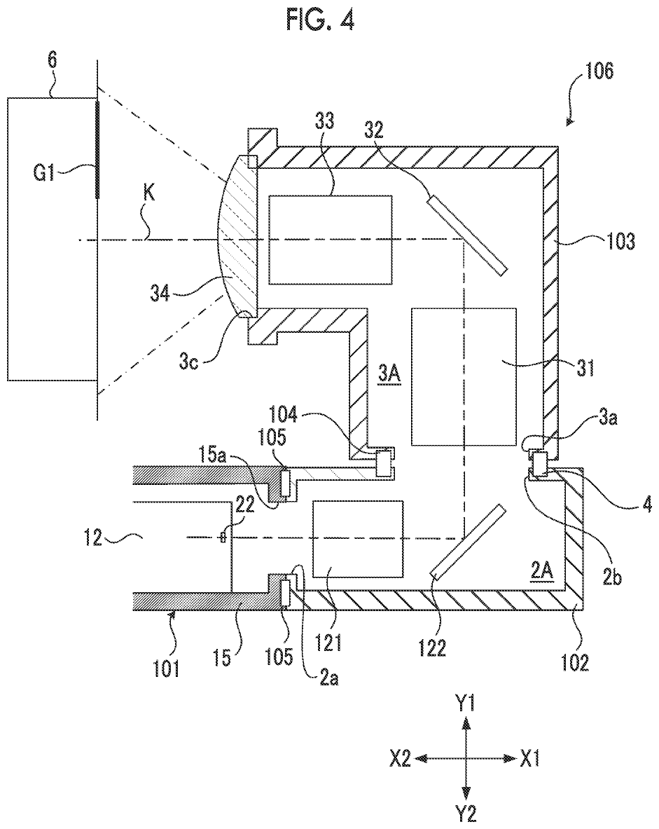

The projection portion 1, the control device 4, and the operation reception portion 2 are implemented by, for example, a single device (for example, see FIGS. 3 and 4). Alternatively, the projection portion 1, the control device 4, and the operation reception portion 2 may be separate devices that cooperate by communicating with each other.

### <Internal Configuration of Projection Portion 1 Shown in FIG. 1>

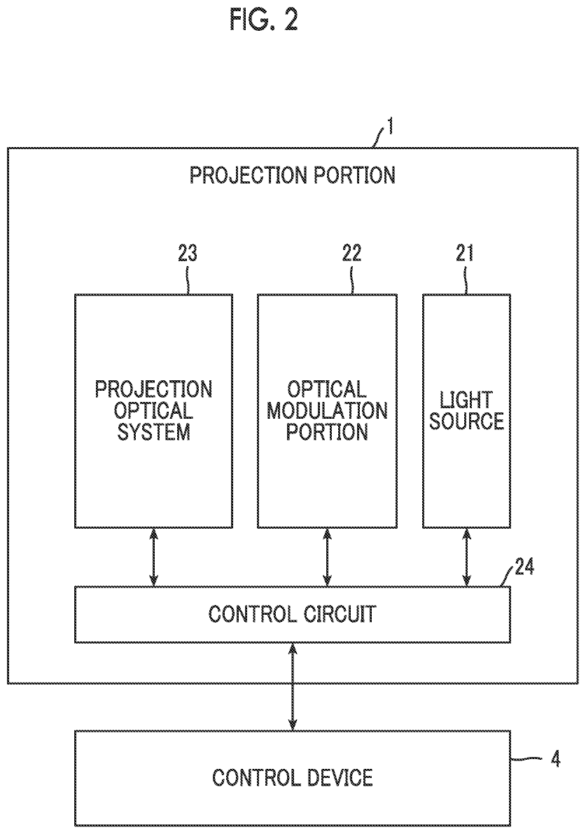

FIG. 2 is a schematic diagram showing an example of an internal configuration of the projection portion 1 shown in FIG. 1.

As shown in FIG. 2, the projection portion 1 comprises a light source 21, an optical modulation portion 22, a projection optical system 23, and a control circuit 24.

The light source 21 includes a light emitting element such as a laser or a light emitting diode (LED) and emits, for example, white light.

The optical modulation portion 22 is composed of three liquid crystal panels that emit each color image by modulating, based on image information, each color light beam which is emitted from the light source 21 and is separated into three colors of red, blue, and green by a color separation mechanism (not shown). Filters of red, blue, and green may be mounted in each of the three liquid crystal panels, and each color image may be emitted by modulating the white light emitted from the light source 21 in each liquid crystal panel.

The light from the light source 21 and the optical modulation portion 22 is incident on the projection optical system 23. The projection optical system 23 includes at least one lens and is composed of, for example, a relay optical system. The light that has passed through the projection optical system 23 is projected onto the projection object 6.

In the projection object 6, a region irradiated with the light transmitted through the entire range of the optical modulation portion 22 is the projectable range in which the projection can be performed by the projection portion 1. Within this projectable range, a region irradiated with the light actually transmitted through the optical modulation portion 22 is the projection surface 11. For example, in the projectable range, a size, a position, and a shape of the projection surface 11 are changed by controlling a size, a position, and a shape of a region through which the light is transmitted in the optical modulation portion 22.

The control circuit 24 controls the light source 21, the optical modulation portion 22, and the projection optical system 23 based on the display data input from the control device 4, thereby projecting an image based on this display data onto the projection object 6. The display data input to the control circuit 24 is composed of three pieces of data including red display data, blue display data, and green display data.

In addition, the control circuit 24 changes the projection optical system 23 based on an instruction input from the control device 4, thereby enlarging or reducing the projection surface 11 (see FIG. 1) of the projection portion 1. In addition, the control device 4 may move the projection surface 11 of the projection portion 1 by changing the projection optical system 23 based on the operation received by the operation reception portion 2 from the user.

The projection apparatus 10 also comprises a shift mechanism that mechanically or optically moves the projection surface 11 while maintaining an image circle of the projection optical system 23. The image circle of the projection optical system 23 is a region where the projection light incident on the projection optical system 23 appropriately passes through the projection optical system 23 in terms of a light fall-off, color separation, edge part curvature, or the like.

The shift mechanism is implemented by at least any of an optical system shift mechanism that performs optical system shifting or an electronic shift mechanism that performs electronic shifting.

The optical system shift mechanism is, for example, a mechanism (for example, see FIGS. 3 and 4) that moves the projection optical system 23 in a direction perpendicular to an optical axis or a mechanism that moves the optical modulation portion 22 in the direction perpendicular to the optical axis instead of moving the projection optical system 23. Furthermore, the optical system shift mechanism may perform the movement of the projection optical system 23 and the movement of the optical modulation portion 22 in combination with each other.

The electronic shift mechanism is a mechanism that performs pseudo shifting of the projection surface 11 by changing a range through which the light is transmitted in the optical modulation portion 22.

The projection apparatus 10 may also comprise a projection direction changing mechanism that moves the image circle of the projection optical system 23 and the projection surface 11. The projection direction changing mechanism is a mechanism that changes a projection direction of the projection portion 1 by changing the orientation of the projection portion 1 through mechanical rotation (for example, see FIGS. 3 and 4).

### <Mechanical Configuration of Projection Apparatus 10>

FIG. 3 is a schematic diagram showing an external configuration of the projection apparatus 10. FIG. 4 is a schematic cross-sectional view of an optical unit 106 of the projection apparatus 10 shown in FIG. 3. FIG. 4 shows a cross section in a plane along an optical path of light emitted from a body part 101 shown in FIG. 3.

As shown in FIG. 3, the projection apparatus 10 comprises the body part 101 and the optical unit 106 that is provided to protrude from the body part 101. In the configuration shown in FIG. 3, the operation reception portion 2, the control device 4, and the light source 21, the optical modulation portion 22, and the control circuit 24 in the projection portion 1 are provided in the body part 101. The projection optical system 23 in the projection portion 1 is provided in the optical unit 106.

The optical unit 106 comprises a first member 102 supported by the body part 101 and a second member 103 supported by the first member 102.

The first member 102 and the second member 103 may be an integrated member. The optical unit 106 may be configured to be attachable to and detachable from the body part 101 (in other words, configured to be interchangeable).

The body part 101 includes a housing 15 (see FIG. 4) in which an opening 15a (see FIG. 4) for passing light is formed in a part connected to the optical unit 106.

As shown in FIG. 3, the light source 21 and an optical modulation unit 12 including the optical modulation portion 22 (see FIG. 2) that generates an image by spatially modulating the light emitted from the light source 21 based on input image data are provided inside the housing 15 of the body part 101.

The light emitted from the light source 21 is incident on the optical modulation portion 22 of the optical modulation unit 12 and is spatially modulated and emitted by the optical modulation portion 22.

As shown in FIG. 4, the image formed by the light spatially modulated by the optical modulation unit 12 is incident on the optical unit 106 by passing through the opening 15a of the housing 15 and is projected onto the projection object 6 as a projection target object. Accordingly, an image G1 is visible from an observer.

As shown in FIG. 4, the optical unit 106 comprises the first member 102 including a hollow portion 2A connected to the inside of the body part 101, the second member 103 including a hollow portion 3A connected to the hollow portion 2A, a first optical system 121 and a reflective member 122 disposed in the hollow portion 2A, a second optical system 31, a reflective member 32, a third optical system 33, and a lens 34 disposed in the hollow portion 3A, a shift mechanism 105, and a projection direction changing mechanism 104.

The first member 102 is a member having, for example, a rectangular cross-sectional outer shape, in which an opening 2a and an opening 2b are formed in surfaces perpendicular to each other. The first member 102 is supported by the body part 101 in a state in which the opening 2a is disposed at a position facing the opening 15a of the body part 101. The light emitted from the optical modulation portion 22 of the optical modulation unit 12 of the body part 101 is incident into the hollow portion 2A of the first member 102 through the opening 15a and the opening 2a.

The incidence direction of the light incident into the hollow portion 2A from the body part 101 will be referred to as a direction X1, the direction opposite to the direction X1 will be referred to as a direction X2, and the direction X1 and the direction X2 will be collectively referred to as a direction X. In FIG. 4, the direction from the front to the back of the page and the opposite direction thereto will be referred to as a direction Z. In the direction Z, the direction from the front to the back of the page will be referred to as a direction Z1, and the direction from the back to the front of the page will be referred to as a direction Z2.

In addition, the direction perpendicular to the direction X and to the direction Z will be referred to as a direction Y. In the direction Y, the upward direction in FIG. 4 will be referred to as a direction Y1, and the downward direction in FIG. 4 will be referred to as a direction Y2. In the example in FIG. 4, the projection apparatus 10 is disposed such that the direction Y2 is the vertical direction.

The projection optical system 23 shown in FIG. 2 is composed of the first optical system 121, the reflective member 122, the second optical system 31, the reflective member 32, the third optical system 33, and the lens 34. An optical axis K of the projection optical system 23 is shown in FIG. 4. The first optical system 121, the reflective member 122, the second optical system 31, the reflective member 32, the third optical system 33, and the lens 34 are disposed in this order from the optical modulation portion 22 side along the optical axis K.

The first optical system 121 includes at least one lens and guides the light that is incident on the first member 102 from the body part 101 and travels in the direction X1 to the reflective member 122.

The reflective member 122 reflects the light incident from the first optical system 121 in the direction Y1. The reflective member 122 is composed of, for example, a mirror. In the first member 102, the opening 2b is formed on the optical path of light reflected by the reflective member 122, and the reflected light travels to the hollow portion 3A of the second member 103 by passing through the opening 2b.

The second member 103 is a member having an approximately T-shaped cross-sectional outer shape, in which an opening 3a is formed at a position facing the opening 2b of the first member 102. The light that has passed through the opening 2b of the first member 102 from the body part 101 is incident into the hollow portion 3A of the second member 103 through the opening 3a. The first member 102 and the second member 103 may have any cross-sectional outer shape and are not limited to the above.

The second optical system 31 includes at least one lens and guides the light incident from the first member 102 to the reflective member 32.

The reflective member 32 reflects the light incident from the second optical system 31 in the direction X2 and guides the light to the third optical system 33. The reflective member 32 is composed of, for example, a mirror.

The third optical system 33 includes at least one lens and guides the light reflected by the reflective member 32 to the lens 34.

The lens 34 is disposed at an end part of the second member 103 on the direction X2 side in a form of closing the opening 3c formed at this end part. The lens 34 projects the light incident from the third optical system 33 onto the projection object 6.

The projection direction changing mechanism 104 is a rotation mechanism that rotatably connects the second member 103 to the first member 102. By the projection direction changing mechanism 104, the second member 103 is configured to be rotatable about a rotation axis (specifically, the optical axis K) that extends in the direction Y. The projection direction changing mechanism 104 is not limited to the disposition position shown in FIG. 4 as long as the projection direction changing mechanism 104 can rotate the optical system. Furthermore, the number of rotation mechanisms is not limited to one, and a plurality of rotation mechanisms may be provided.

The shift mechanism 105 is a mechanism for moving the optical axis K of the projection optical system (in other words, the optical unit 106) in a direction (direction Y in FIG. 4) perpendicular to the optical axis K. Specifically, the shift mechanism 105 is configured to be able to change a position of the first member 102 in the direction Y with respect to the body part 101. The shift mechanism 105 may manually move the first member 102 or electrically move the first member 102.

FIG. 4 shows a state in which the first member 102 is moved as far as possible to the direction Y1 side by the shift mechanism 105. By moving the first member 102 in the direction Y2 by the shift mechanism 105 from the state shown in FIG. 4, the relative position between the center of the image (in other words, the center of the display surface) formed by the optical modulation portion 22 and the optical axis K changes, and the image G1 projected onto the projection object 6 can be shifted (translated) in the direction Y2.

The shift mechanism 105 may be a mechanism that moves the optical modulation portion 22 in the direction Y instead of moving the optical unit 106 in the direction Y. Even in this case, the image G1 projected onto the projection object 6 can be moved in the direction Y2.

### <Appearance of Image Processing Apparatus 50>

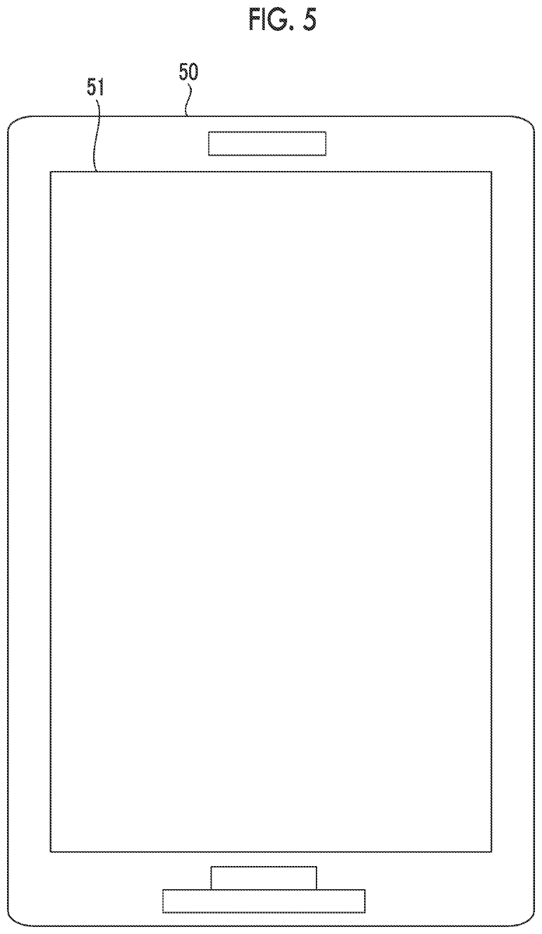

FIG. 5 is a diagram showing an example of an appearance of an image processing apparatus 50. The image processing apparatus 50 is a tablet terminal having a touch panel 51. The touch panel 51 is a display that allows a touch operation. The image processing apparatus 50 displays, on the touch panel 51, an installation support image for supporting installation of the projection apparatus 10 in a space.

Specifically, the image processing apparatus 50 displays, as an installation support image, a second image in which a first virtual projection surface, which is a virtual projection surface, and a first virtual projection apparatus, which is a virtual projection apparatus, are superimposed on a first image obtained by imaging the space in which the projection apparatus 10 is installed and performs the projection.

### <Hardware Configuration of Image Processing Apparatus 50>

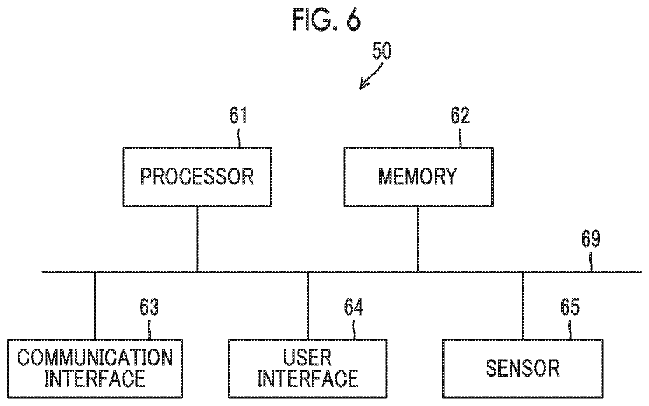

FIG. 6 is a diagram showing an example of a hardware configuration of the image processing apparatus 50. For example, as shown in FIG. 6, the image processing apparatus 50 shown in FIG. 5 comprises a processor 61, a memory 62, a communication interface 63, a user interface 64, and a sensor 65. The processor 61, the memory 62, the communication interface 63, the user interface 64, and the sensor 65 are connected by, for example, a bus 69.

The processor 61 is a circuit that performs signal processing, and is, for example, a CPU that controls the entire image processing apparatus 50. The processor 61 may be implemented by other digital circuits such as an FPGA and a digital signal processor (DSP). The processor 61 may also be implemented by combining a plurality of digital circuits.

For example, the memory 62 includes a main memory and an auxiliary memory. For example, the main memory is a random-access memory (RAM). The main memory is used as a work area of the processor 61.

The auxiliary memory is, for example, a non-volatile memory such as a magnetic disk or a flash memory. The auxiliary memory stores various programs for operating the image processing apparatus 50. The programs stored in the auxiliary memory are loaded into the main memory and executed by the processor 61.

In addition, the auxiliary memory may include a portable memory that can be detached from the image processing apparatus 50. Examples of the portable memory include a memory card such as a universal serial bus (USB) flash drive or a secure digital (SD) memory card, and an external hard disk drive.

The communication interface 63 is a communication interface for communicating with apparatuses outside the image processing apparatus 50. The communication interface 63 includes at least any of a wired communication interface for performing wired communication or a wireless communication interface for performing wireless communication. The communication interface 63 is controlled by the processor 61.

The user interface 64 includes, for example, an input device that receives an operation input from the user, and an output device that outputs information to the user. The input device can be implemented by, for example, a key (for example, a keyboard) or a remote controller. The output device can be implemented by, for example, a display or a speaker. In the image processing apparatus 50 shown in FIG. 5, the input device and the output device are implemented by the touch panel 51. The user interface 64 is controlled by the processor 61. The image processing apparatus 50 receives various types of designation from the user using the user interface 64.

The sensor 65 includes an imaging apparatus that includes an imaging optical system and an imaging element and that can perform imaging, a space recognition sensor that can three-dimensionally recognize a space around the image processing apparatus 50, and the like. For example, the imaging apparatus includes an imaging apparatus provided on a rear surface of the image processing apparatus 50 shown in FIG. 5.

The space recognition sensor is, as an example, a light detection and ranging (LiDAR) sensor of performing irradiation with laser light, measuring a time taken until the laser light of irradiation hits an object and reflects back, and measuring a distance and a direction to the object. However, the space recognition sensor is not limited thereto and can be various sensors such as a radar that emits radio waves, and an ultrasonic sensor that emits ultrasound waves.

### <Acquisition of Posture of Imaging Apparatus of Image Processing Apparatus 50>

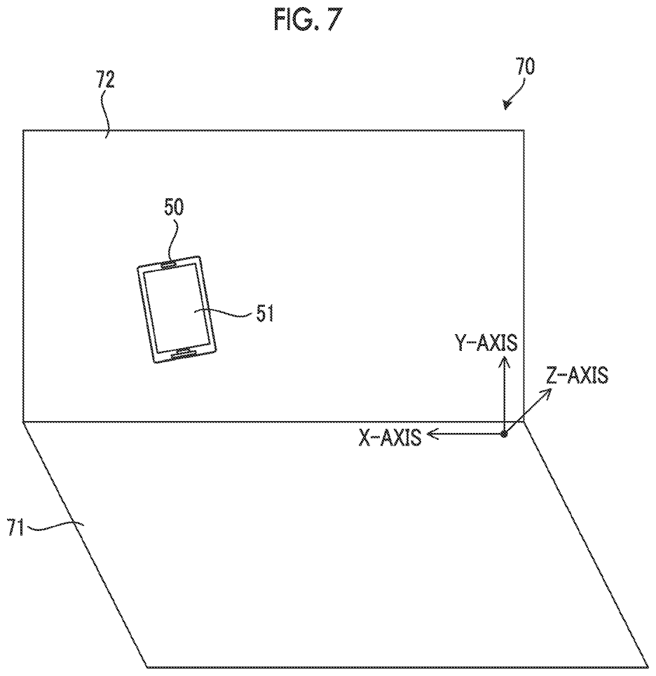

FIG. 7 is a diagram showing an example of acquiring a posture of an imaging apparatus of the image processing apparatus 50. As shown in FIG. 7, for example, the user of the image processing apparatus 50 brings the image processing apparatus 50 into a physical space 70 (for example, a room) that is a physical space where the projection apparatus 10 is to be installed. In the example of FIG. 7, at least a floor 71 and a wall 72 are present as physical planes in the physical space 70.

The image processing apparatus 50 constantly acquires the posture (position and orientation) of the imaging apparatus of the image processing apparatus 50 in a three-dimensional orthogonal coordinate system in which one point (for example, a position at which the imaging apparatus of the image processing apparatus 50 is activated) in the physical space 70 is set as an origin, a horizontal direction is set as an X-axis, a direction of gravitational force is set as a Y-axis, and the remaining axis is set as a Z-axis. Further, the image processing apparatus 50 displays a captured image based on imaging data obtained by imaging using the imaging apparatus on the touch panel 51 as a through-image (live view) to the user.

### <Imaging of First Image and Acquisition of First Position>

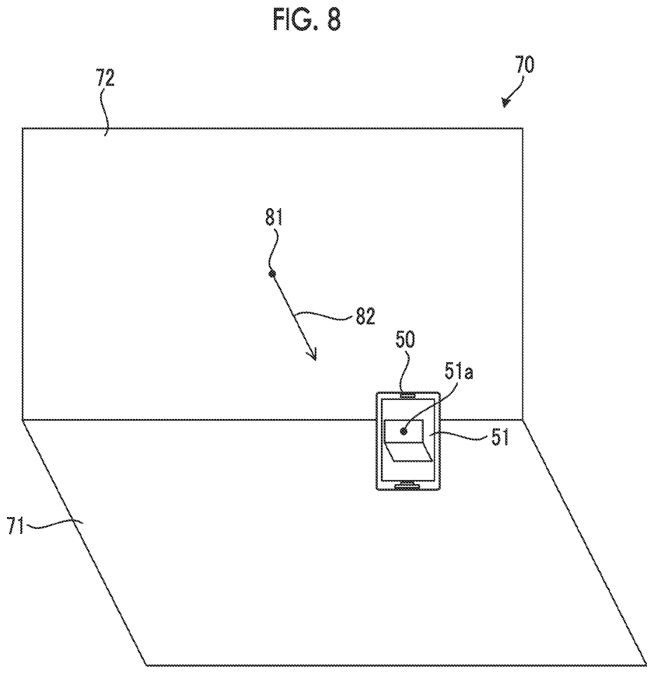

FIG. 8 is a diagram showing an example of imaging a first image and acquiring a first position. Here, it is assumed that a user intends to set a first position 81 near the center of the wall 72 as a position (center position) at which the projection surface 11 of the projection apparatus 10 is disposed. In this case, as shown in FIG. 8, the user holds the image processing apparatus 50 at a position and an orientation at which the first position 81 is displayed on the touch panel 51.

Then, the user gives an instruction for the first position 81 in the physical space 70 by performing an instruction operation (for example, tap operation) on the first position 81 (a position 51a of the touch panel 51) of the wall 72 displayed on the touch panel 51. Accordingly, the image processing apparatus 50 can acquire first position data representing the first position 81 in the three-dimensional orthogonal coordinate system shown in FIG. 7.

A first normal vector 82 is a normal vector of a first surface corresponding to the wall 72, which is an object present at the first position 81 in the physical space 70, in the three-dimensional orthogonal coordinate system shown in FIG. 7. The image processing apparatus 50 acquires first normal vector data representing the first normal vector 82 based on a result of recognizing the physical space 70 with a space recognition sensor.

### <Physical Space Image Represented by First Image Data Obtained by Imaging Physical Space 70>

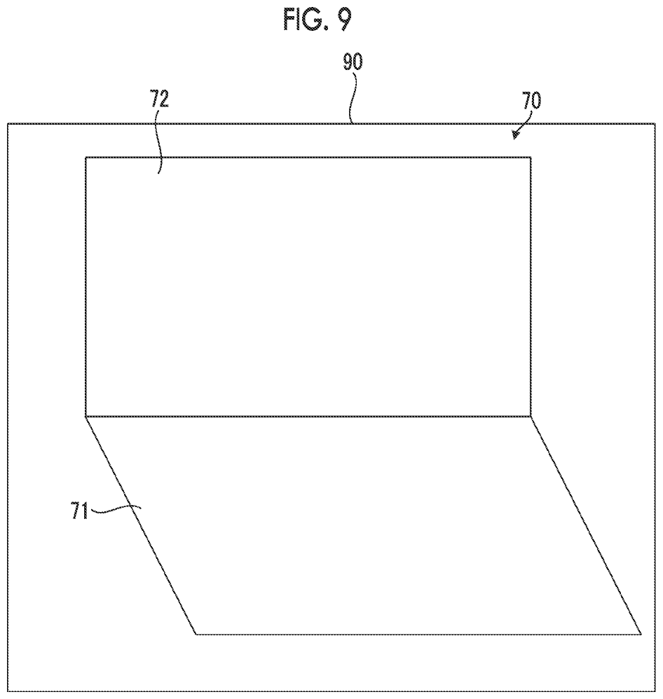

FIG. 9 is a diagram showing an example of a physical space image represented by first image data obtained by imaging the physical space 70. In the state shown in FIG. 8, the user instructs the image processing apparatus 50 to perform imaging with a composition in which the first position 81 appears on the touch panel 51. Accordingly, the image processing apparatus 50 can acquire the first image data obtained by imaging the physical space 70 including the first position 81. The first image data is data that represents a physical space image 90 in which the physical space 70 is captured. The physical space image 90 is an example of a first image according to the embodiment of the present invention.

Accordingly, the image processing apparatus 50 can acquire first image data obtained by imaging the physical space 70, first position data representing the first position 81 in the physical space 70, and first normal vector data representing the first normal vector 82 of a first surface corresponding to an object present at the first position 81 in the physical space 70. For example, the image processing apparatus 50 stores first position data and first normal vector data indicating the first position 81 and the first normal vector 82 expressed in the three-dimensional orthogonal coordinate system described with reference to FIG. 7. In this case, in addition to these pieces of data, the image processing apparatus 50 also stores data indicating the position of the image processing apparatus 50 when the physical space 70 was imaged to obtain first image data. Alternatively, when the physical space 70 was imaged, the image processing apparatus 50 stores first position data and first normal vector data indicating the first position 81 and the first normal vector 82 expressed in a three-dimensional orthogonal coordinate system centered on the image processing apparatus 50 based on the posture of the image processing apparatus 50, which is constantly acquired.

### <Processing of Image Processing Apparatus 50>

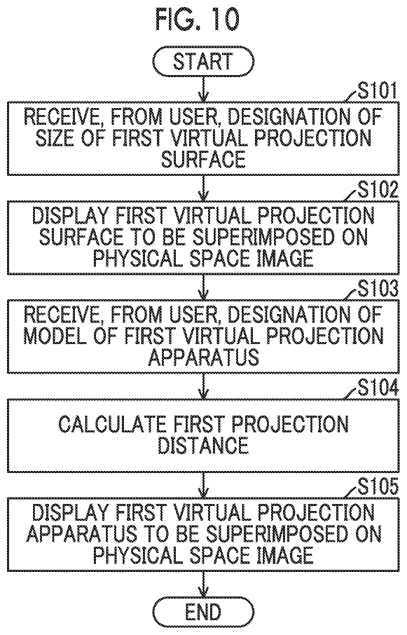

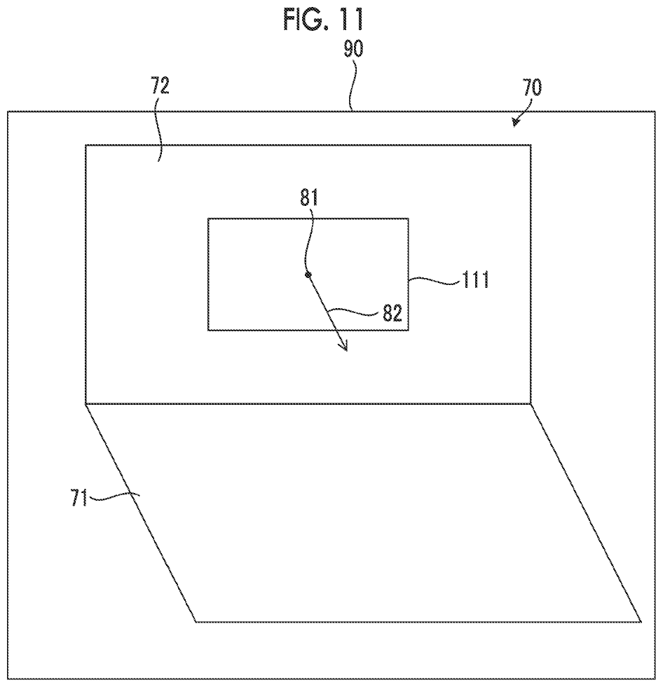

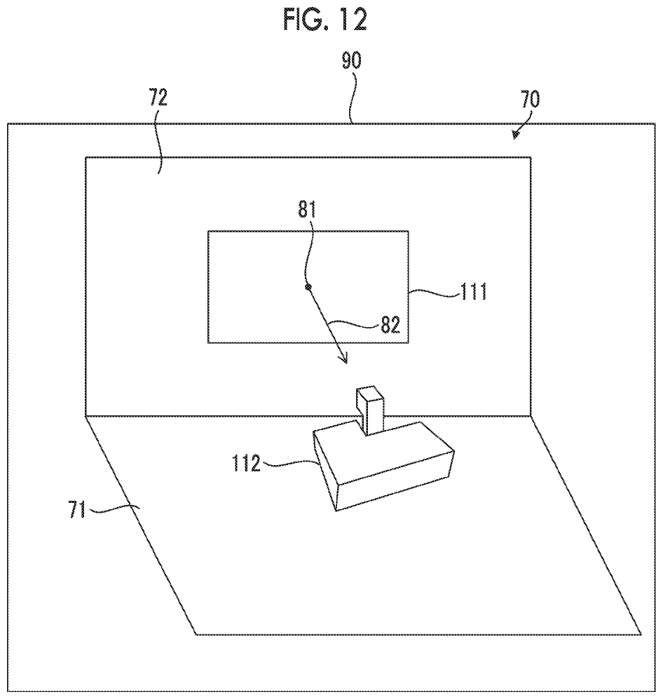

FIG. 10 is a flowchart showing an example of processing of the image processing apparatus 50. FIGS. 11 and 12 are examples of images displayed by the image processing apparatus 50 in the processing shown in FIG. 10. At the start of the processing shown in FIG. 10, it is assumed that the image processing apparatus 50 has acquired first image data obtained by imaging the physical space 70, first position data representing the first position 81 in the physical space 70, and first normal vector data representing the first normal vector 82 of a first surface corresponding to the wall 72 present at the first position 81 in the physical space 70 as described with reference to FIGS. 7 to 9.

First, the image processing apparatus 50 receives, from the user, designation of the size of the first virtual projection surface (Step S101). The size of the first virtual projection surface is designated using an actual distance in the physical space 70, for example, the length of the diagonal line of the rectangular first virtual projection surface=x [inches].

Next, the image processing apparatus 50 displays the first virtual projection surface to be superimposed on the physical space image 90 represented by the first image data based on the size of the first virtual projection surface designated in Step S101 and the above-mentioned first position data and first normal vector data (Step S102). For example, as shown in FIG. 11, the image processing apparatus 50 displays an image obtained by superimposing a first virtual projection surface 111 on the physical space image 90.

Specifically, the image processing apparatus 50 generates a first virtual projection surface 111 in the physical space image 90, the first virtual projection surface 111 being centered on the first position 81 represented by the first position data, being perpendicular to the first normal vector 82 represented by the first normal vector data, and having its shape adjusted such that it appears as a projection surface of a designated size, and displays the generated first virtual projection surface 111 to be superimposed on the physical space image 90. Although the first position 81 and the first normal vector 82 are shown in FIG. 11, the first position 81 and the first normal vector 82 may not be actually displayed.

Next, the image processing apparatus 50 receives, from the user, designation of the model of the first virtual projection apparatus from among a plurality of options of the model of the projection apparatus 10 (Step S103). Next, the image processing apparatus 50 calculates a first projection distance, which is the distance between the first virtual projection apparatus and the first virtual projection surface 111, based on the size of the first virtual projection surface 111 and the projection ratio that can be set for the model that has been designated as the model of the first virtual projection apparatus in Step S103 (Step S104).

Next, the image processing apparatus 50 displays the first virtual projection apparatus to be superimposed on the physical space image 90 based on the model of the first virtual projection apparatus designated in Step S103 and the first projection distance calculated in Step S104 (Step S105). For example, as shown in FIG. 12, the image processing apparatus 50 displays a first virtual projection apparatus 112, which is a three-dimensional model of a model designated as the model of the first virtual projection apparatus, to be superimposed on the physical space image 90.

Specifically, the image processing apparatus 50 generates a first virtual projection apparatus 112 in the physical space image 90, the shape of which is adjusted such that it appears to be disposed at a position away from the center (first position 81) of the first virtual projection surface 111 in the direction of the first normal vector 82 by a first projection distance, and displays the generated first virtual projection apparatus 112 to be superimposed on the physical space image 90. Although the first position 81 and the first normal vector 82 are shown in FIG. 12, the first position 81 and the first normal vector 82 may not be actually displayed.

In this way, the image processing apparatus 50 generates second image data representing a second image in which the first virtual projection surface 111 and the first virtual projection apparatus 112 are displayed to be superimposed on the first image (physical space image 90) represented by the first image data, based on the first image data, the first virtual projection surface data, and the first virtual projection apparatus data, and displays the second image based on the second image data.

Accordingly, by acquiring the first position data, the first normal vector data, and the physical space image 90 (first image) in the physical space 70, the user can visually ascertain the size and the disposition of the projection surface 11 based on the physical plane (wall 72) of the physical space 70, and the positional relationship between the projection surface 11 and the projection apparatus 10 on the physical space image 90 representing the physical space 70, even in places other than the physical space 70 where projection is to be performed by the projection apparatus 10.

Furthermore, since it is sufficient to acquire the first position data and the first normal vector data as space data representing the physical space 70, and it is not necessary to acquire detailed three-dimensional data of the physical space 70, the amount of data to be held can be reduced.

In generating the second image data, specifically, the image processing apparatus 50 generates first virtual projection surface data based on the first position data and the first normal vector data, and generates first virtual projection apparatus data based on the generated first virtual projection surface data.

Furthermore, the image processing apparatus 50 determines the normal vector of the first virtual projection surface 111 in accordance with the first normal vector 82 represented by the first normal vector data. For example, the image processing apparatus 50 generates a first virtual projection surface 111 such that the direction of the normal vector of the first virtual projection surface 111 matches the direction of the first normal vector 82. In the present application, “match” does not necessarily mean a perfect match, but also includes a general match.

In addition, the image processing apparatus 50 determines the projection direction and the position of the first virtual projection apparatus 112 represented by the first virtual projection apparatus data based on the position and the size of the first virtual projection surface 111.

In addition, the image processing apparatus 50 determines first position data and first normal vector data based on distance data regarding the distance (first projection distance) between the object (wall 72) and the imaging apparatus (the imaging apparatus of the image processing apparatus 50) obtained by the space recognition sensor.

### <Another Example of Acquiring First Position>

In FIG. 8, the configuration has been described in which the user gives an instruction for the first position 81 in the physical space 70 by performing an instruction operation (for example, a tap operation) on the first position 81 of the wall 72 displayed on the touch panel 51, but the present invention is not limited to such a configuration. For example, in a case in which the image processing apparatus 50 is able to detect the end part of the physical plane on which the first virtual projection surface 111 is disposed in the physical space 70 at the time of imaging the physical space 70, the image processing apparatus 50 may determine the first position 81 based on the position of the detected end part.

<Detection of End Part of Physical Plane in which First Virtual Projection Surface 111 is Disposed in Physical Space 70>

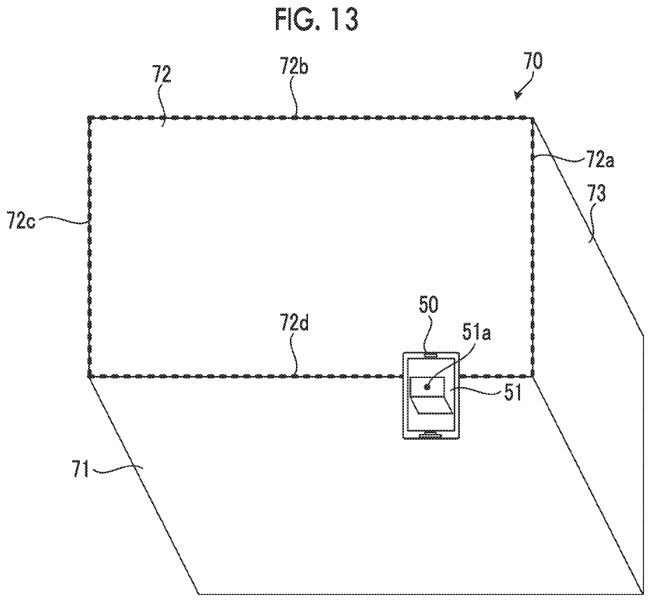

FIG. 13 is a diagram showing an example of detecting an end part of a physical plane in which the first virtual projection surface 111 is disposed in the physical space 70. In the example of FIG. 13, a wall 73 is present in the physical space 70. The wall 73 is a wall perpendicular to the floor 71 and the wall 72. For example, in a case in which the physical plane on which the first virtual projection surface 111 is disposed in the physical space 70 is the wall 72, the image processing apparatus 50 detects end parts 72a to 72d shown in FIG. 13.

The end part 72a is a right end part (a boundary part with the wall 73) of the wall 72. The end part 72b is an upper end part of the wall 72. The end part 72c is a left end part of the wall 72. The end part 72d is a lower end part of the wall 72.

The end parts 72a to 72d can be detected, for example, by image recognition processing based on imaging data obtained by imaging using an imaging apparatus of the image processing apparatus 50, or based on the recognition results from a space recognition sensor of the image processing apparatus 50.

### <Determination Processing of First Position 81>

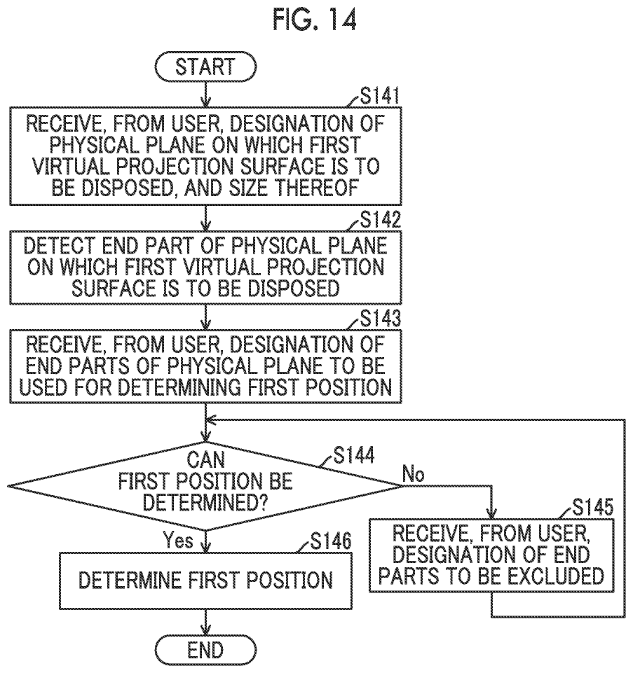

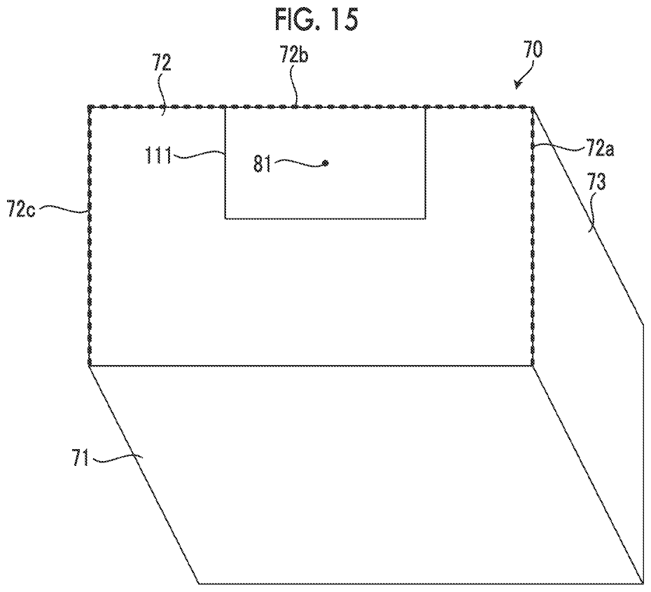

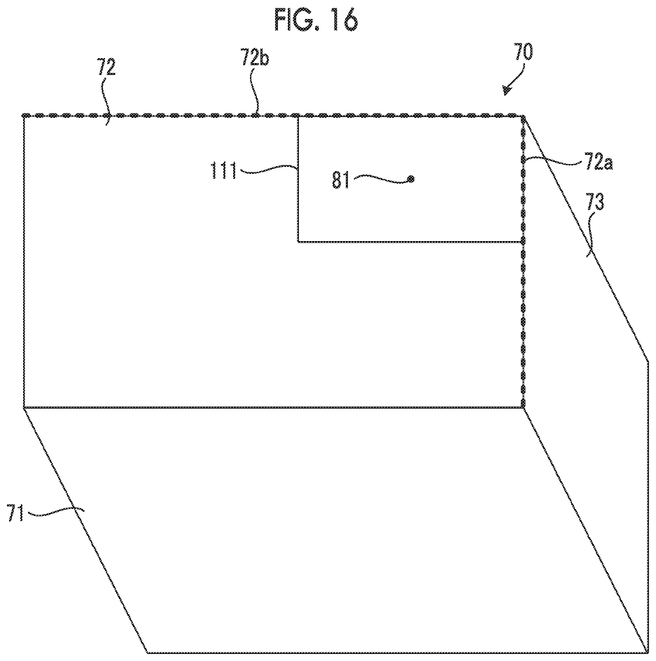

FIG. 14 is a flowchart showing an example of determination processing of the first position 81. FIGS. 15 and 16 are diagrams showing an example of determining the first position 81 in the determination processing of FIG. 14. The image processing apparatus 50 executes, for example, the processing shown in FIG. 14 while displaying, to the user on the touch panel 51, the physical space image 90 represented by first image data obtained by imaging the physical space 70.

First, the image processing apparatus 50 receives, from the user, designation of the physical plane (wall 72) on which the first virtual projection surface 111 is to be disposed in the physical space 70, and the size of the first virtual projection surface 111 (Step S141). For example, the user gives an instruction for the wall 72 in the physical space 70 by performing an instruction operation (for example, a tap operation) on the wall 72 displayed on the touch panel 51.

Next, the image processing apparatus 50 detects the end part of the physical plane (wall 72) received from the user in Step S141 (Step S142). For example, as shown in FIG. 13, the image processing apparatus 50 detects the end parts 72a to 72d of the wall 72.

Next, the image processing apparatus 50 receives, from the user, designation of one or more end parts to be used for determining the first position 81 among the end parts of the physical plane (wall 72) detected in Step S142 (Step S143). For example, the image processing apparatus 50 displays the detected end parts 72a to 72d of the wall 72 as candidates on the touch panel 51, and receives the designation of the end part from the user through a tap operation or the like.

Next, the image processing apparatus 50 determines, based on the size of the first virtual projection surface 111 designated in Step S141, whether or not the first position 81 can be determined such that the sides of the first virtual projection surface 111 are in contact with all of the end parts designated in Step S143 (Step S144).

For example, it is assumed that the end parts 72a to 72c of the wall 72 are designated by the user in Step S143. In addition, it is assumed that the size (for example, width) of the first virtual projection surface 111 designated in Step S141 is different from the size (for example, the width) of the wall 72. In this case, as shown in FIG. 15, it is not possible to determine the first position 81 such that the sides of the first virtual projection surface 111 having the size designated in Step S141 are in contact with all of the end parts 72a to 72c. In addition, FIG. 15 shows an example in which the first position 81 is determined such that the side of the first virtual projection surface 111 is in contact with only the end part 72b among the end parts 72a to 72c.

In Step S144, in a case in which the first position 81 cannot be determined (Step S144: No), the image processing apparatus 50 outputs, to the user, a message prompting the user to exclude some of the end parts designated as the end parts to be used in determining the first position 81, and receives the designation of the end parts to be excluded (Step S145).

Then, the image processing apparatus 50 returns to Step S144 and again determines whether or not the first position 81 can be determined such that the sides of the first virtual projection surface 111 are in contact with all of the end parts, excluding the end parts designated in Step S145. For example, it is assumed that the end part 72c of the wall 72 is designated to be excluded from the end parts 72a to 72c. In this case, for example, as shown in FIG. 16, the first position 81 can be determined such that the sides of the first virtual projection surface 111 are in contact with all of the designated end parts 72a and 72b.

In Step S144, in a case in which the first position 81 can be determined (Step S144: Yes), the image processing apparatus 50 determines the first position 81 such that the sides of the first virtual projection surface 111 are in contact with all of the designated end parts (Step S146), and ends the series of processes. For example, the image processing apparatus 50 determines the first position 81 shown in FIG. 16. This makes it possible to easily determine the first position 81 where the first virtual projection surface 111 can be brought closer to the end part of the wall 72.

### <Another Example of Acquiring Size of First Virtual Projection Surface 111>

Although the configuration has been described in which the user gives an instruction regarding the size of the first virtual projection surface 111, the present invention is not limited to such a configuration. For example, in a case in which the image processing apparatus 50 is able to detect the end part of the physical plane on which the first virtual projection surface 111 is disposed in the physical space 70 at the time of imaging the physical space 70, the image processing apparatus 50 may determine the size of the first virtual projection surface 111 based on the position of the detected end part.

### <Determination Processing of Size of First Virtual Projection Surface 111>

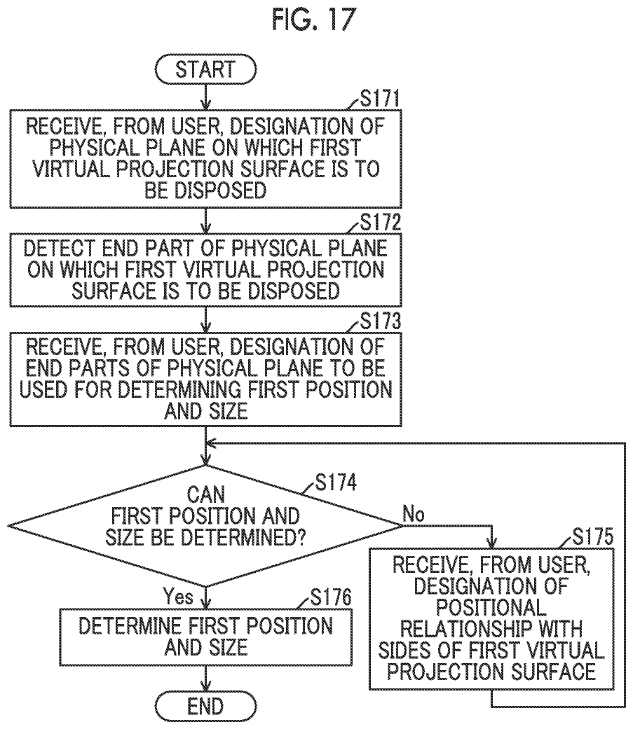

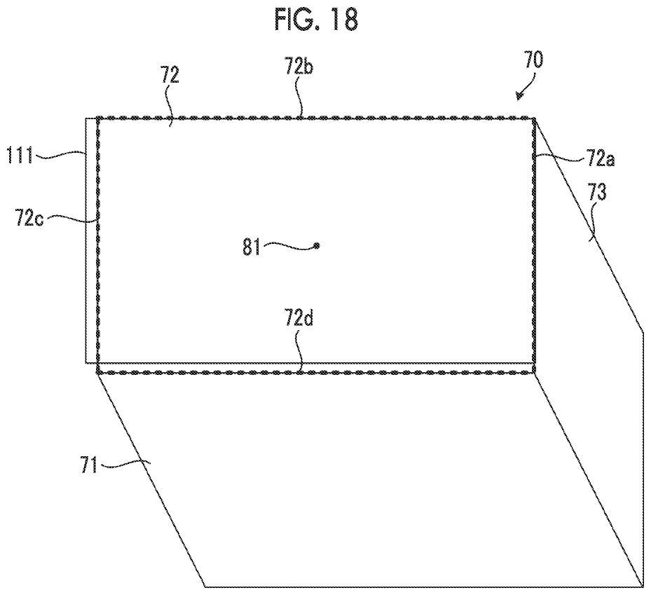

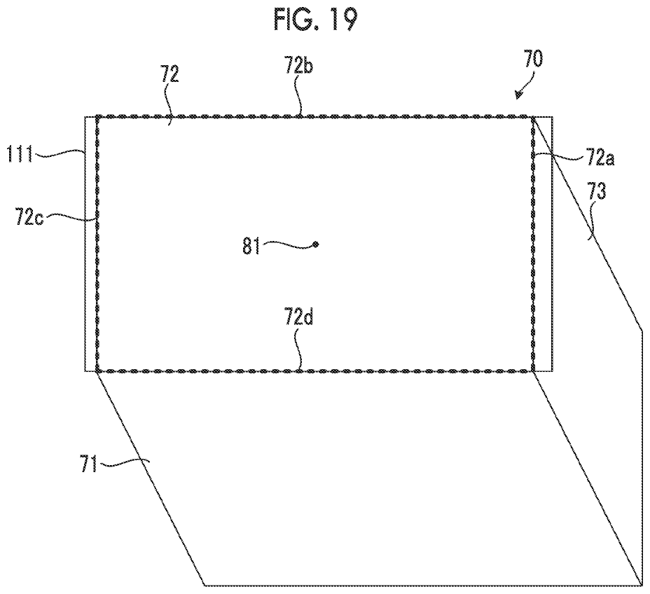

FIG. 17 is a flowchart showing an example of determination processing of the size of the first virtual projection surface 111. FIGS. 18 and 19 are diagrams showing an example of determining the size of the first virtual projection surface 111 and the first position 81 in the determination processing of FIG. 17. The image processing apparatus 50 executes, for example, the processing shown in FIG. 17 while displaying, to the user on the touch panel 51, the physical space image 90 represented by first image data obtained by imaging the physical space 70.

First, the image processing apparatus 50 receives, from the user, designation of the physical plane (wall 72) on which the first virtual projection surface 111 is to be disposed in the physical space 70 (Step S171). For example, the user gives an instruction for the wall 72 in the physical space 70 by performing an instruction operation (for example, a tap operation) on the wall 72 displayed on the touch panel 51.

Next, the image processing apparatus 50 detects the end part of the physical plane (wall 72) received from the user in Step S171 (Step S172). For example, as shown in FIG. 13, the image processing apparatus 50 detects the end parts 72a to 72d of the wall 72.

Next, the image processing apparatus 50 receives, from the user, designation of one or more end parts to be used for determining the size of the first virtual projection surface 111 and the first position 81 among the end parts of the physical plane (wall 72) detected in Step S172 (Step S173). For example, the image processing apparatus 50 displays the detected end parts 72a to 72d of the wall 72 as selection candidates on the touch panel 51, and receives the designation of the end part from the user through a tap operation or the like.

Next, the image processing apparatus 50 determines whether or not the size of the first virtual projection surface 111 and the first position 81 can be determined such that the sides of the first virtual projection surface 111 are in an appropriate position relative to the end parts designated in Step S173 (Step S174).

For example, it is assumed that the end parts 72a to 72d of the wall 72 are designated by the user in Step S173. For example, in a case in which the size (for example, the length of the diagonal line) of the first virtual projection surface 111 and the first position 81 are determined such that the right and upper sides of first virtual projection surface 111 are in contact with the end parts 72a and 72b as shown in FIG. 18, it is assumed that the left and lower sides of the first virtual projection surface 111 are not in contact with the end parts 72c and 72d. In this case, the image processing apparatus 50 determines that the size of the first virtual projection surface 111 and the first position 81 cannot be determined such that the sides of the first virtual projection surface 111 are at appropriate positions with respect to the end parts 72a to 72c.

In Step S174, in a case in which the size of the first virtual projection surface 111 and first position 81 cannot be determined (Step S174: No), the image processing apparatus 50 outputs, to the user, a message prompting the user to designate a positional relationship between some of the end parts designated in Step S173 and the sides of the first virtual projection surface 111, and receives, from the user, the designation of the positional relationship with the sides of the first virtual projection surface 111 (Step S175).

Then, the image processing apparatus 50 returns to Step S174, and again determines, based on the positional relationship designated in Step S175, whether or not the size of the first virtual projection surface 111 and the first position 81 can be determined such that the sides of the first virtual projection surface 111 are in an appropriate position relative to the end parts designated in Step S173.

For example, it is assumed that in Step S175, the positional relationship is designated such that the end parts 72a and 72c are located inside the left and right sides of the first virtual projection surface. In this case, for example, as shown in FIG. 19, the size of the first virtual projection surface 111 and the first position 81 of can be determined such that the left and right sides of the first virtual projection surface 111 are outside the end parts 72a and 72c, and the top and bottom sides of the first virtual projection surface 111 are in contact with the end parts 72b and 72d.

In Step S174, in a case in which the size of the first virtual projection surface 111 and the first position 81 can be determined (Step S174: Yes), the image processing apparatus 50 determines the size of the first virtual projection surface 111 and the first position 81 such that the sides of the first virtual projection surface 111 are in an appropriate position relative to the designated end parts (Step S176), and ends the series of processes. For example, the image processing apparatus 50 determines the size of the first virtual projection surface 111 and the first position 81 shown in FIG. 19. This makes it possible to easily determine the first position 81 where the first virtual projection surface 111 can be brought closer to the end part of the wall 72.

In addition, in Step S175, the image processing apparatus 50 may present to the user how the positional relationship between the end parts of the wall 72 and the sides of the first virtual projection surface 111 needs to be set in order to determine the size of the first virtual projection surface 111 and the first position 81, and prompt the user to designate the exclusion of the end part of the wall 72 or designate the positional relationship.

This makes it possible to easily determine the size of the first virtual projection surface 111 where the size of the first virtual projection surface 111 and the first position 81 can be brought closer to the end part of the wall 72.

As shown in FIGS. 14 to 18, the image processing apparatus 50 may specify a position of an end part of the first surface (wall 72) in the physical space image 90 (first image) based on the first image data, and determine at least any of the position or the size of the first virtual projection surface 111 based on the specify position of the end part.

### <Operation Unit for Moving First Virtual Projection Surface 111>

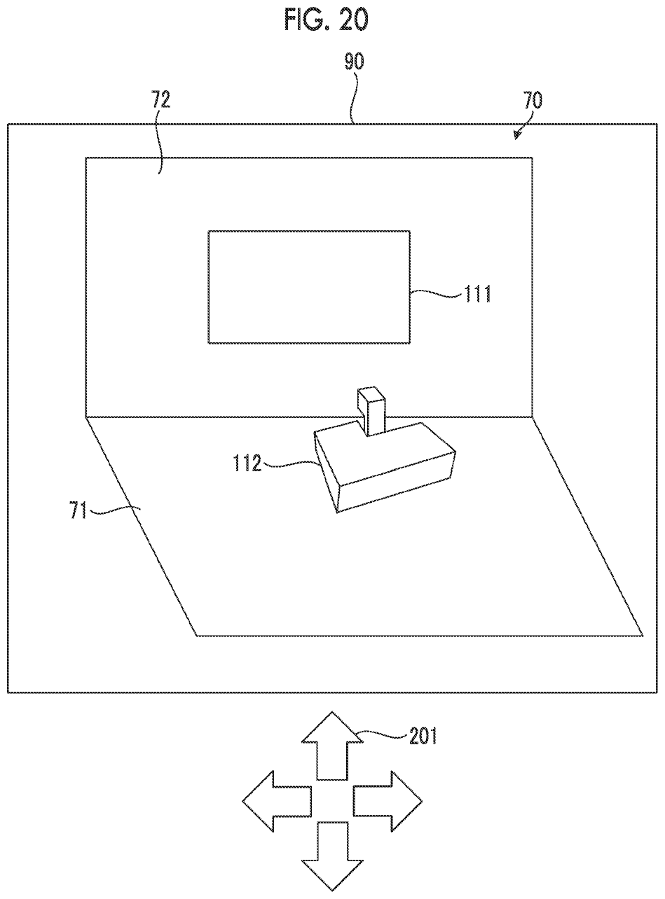

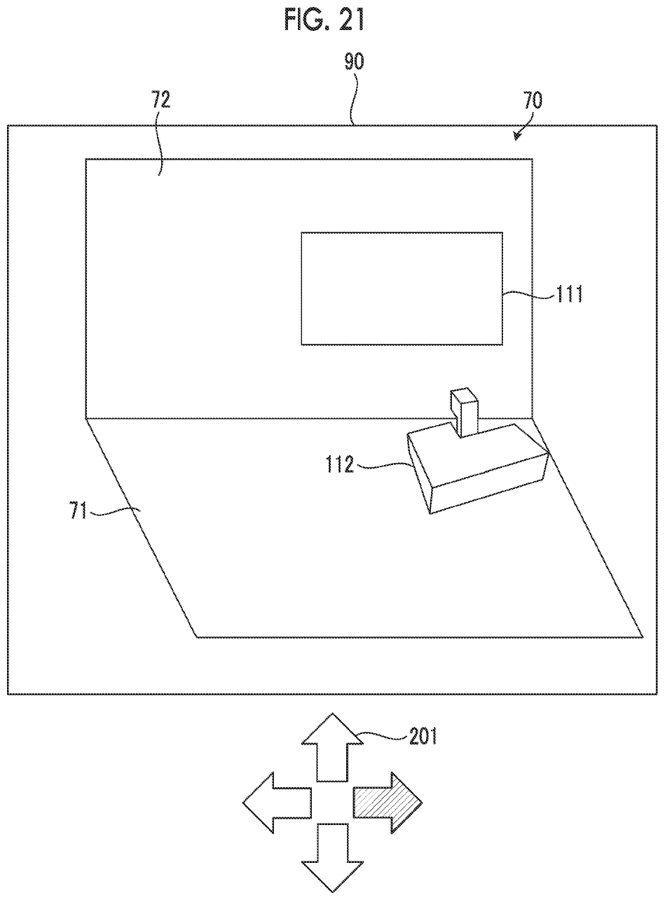

FIGS. 20 and 21 are diagrams showing an example of an operation unit for moving the first virtual projection surface 111. For example, through the processing shown in FIG. 10, the image processing apparatus 50 may further display a first virtual projection surface operation unit 201 as shown in FIG. 20 in a state in which the first virtual projection surface 111 and the first virtual projection apparatus 112 are displayed to be superimposed on the physical space image 90 as shown in FIG. 12 using the touch panel 51. In the examples of FIGS. 20 and 21, the first virtual projection surface operation unit 201 is an image of up, down, left and right cursor keys, and a touch operation can be used to give an instruction to move the first virtual projection surface 111 up, down, left, and right.

For example, as shown in FIG. 21, in a case in which a touch operation is performed on the right cursor key of the first virtual projection surface operation unit 201, the image processing apparatus 50 moves the superimposition position of the first virtual projection surface 111 and the first virtual projection apparatus 112 relative to the physical space image 90 to the right.

Specifically, the image processing apparatus 50 changes the first position 81 in response to an operation of the first virtual projection surface operation unit 201. Then, the image processing apparatus 50 executes processing similar to, for example, Steps S102 and S105 shown in FIG. 10 to display the first virtual projection surface 111 and the first virtual projection apparatus 112 corresponding to the changed first position 81 to be superimposed on the physical space image 90.

### <Operation Unit for Changing Angle of First Virtual Projection Surface 111>

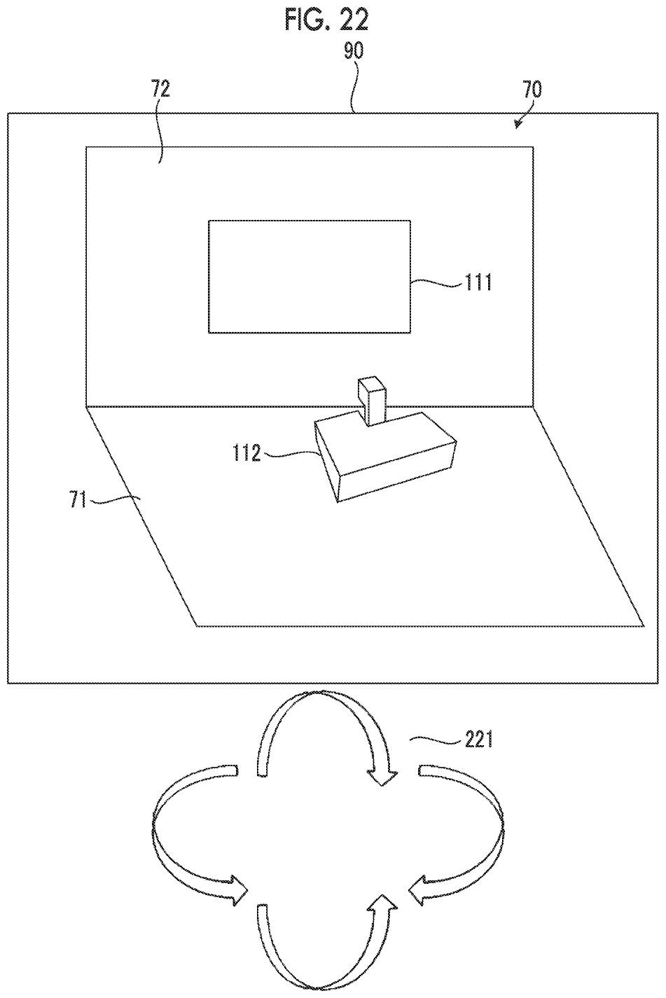

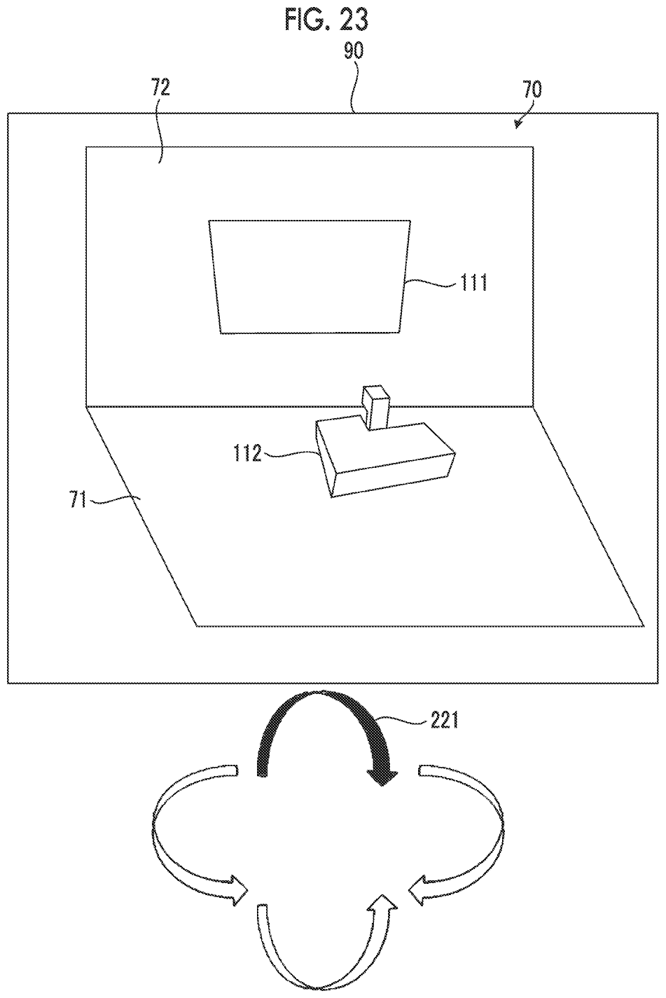

FIGS. 22 and 23 are diagrams showing an example of an operation unit for changing an angle of the first virtual projection surface 111. For example, through the processing shown in FIG. 10, the image processing apparatus 50 may further display a first virtual projection surface operation unit 221 as shown in FIG. 22 in the state in which the first virtual projection surface 111 and the first virtual projection apparatus 112 are displayed to be superimposed on the physical space image 90 as shown in FIG. 12 using the touch panel 51.

In the examples of FIGS. 22 and 23, the first virtual projection surface operation unit 221 is an image of four curved cursor keys, and a touch operation can be used to give an instruction to change an angle of the first virtual projection surface 111. The four curved cursor keys are each used to give an instruction to rotate in a first rotation direction about a horizontal axis, to rotate in a second rotation direction opposite to the first rotation direction, to rotate in a third rotation direction about a vertical axis, and to rotate in a fourth rotation direction opposite to the third rotation direction.

For example, as shown in FIG. 22, in a case in which a touch operation is performed on any of the curved cursor keys of the first virtual projection surface operation unit 221, the image processing apparatus 50 changes the shape of the first virtual projection surface 111 and the first virtual projection apparatus 112 superimposed on the physical space image 90 such that the angles of the first virtual projection surface 111 and the first virtual projection apparatus 112 appear to have changed in the physical space image 90.

Specifically, the image processing apparatus 50 changes the first normal vector 82 in response to an operation of the first virtual projection surface operation unit 221. Then, the image processing apparatus 50 executes processing similar to, for example, Steps S102 and S105 shown in FIG. 10 to display the first virtual projection surface 111 and the first virtual projection apparatus 112 corresponding to the changed first position 81 to be superimposed on the physical space image 90.

In addition, the image processing apparatus 50 may display both the first virtual projection surface operation unit 201 shown in FIGS. 20 and 21 and the first virtual projection surface operation unit 221 shown in FIGS. 22 and 23, and may be able to change both the position and the angle of the first virtual projection surface 111.

As shown in FIGS. 20 to 23, the image processing apparatus 50 may change the first virtual projection surface 111 superimposed on the physical space image 90 based on first input data (for example, data based on an operation on the first virtual projection surface operation unit 201 or the first virtual projection surface operation unit 221) regarding a change in at least any of the first position 81 or the first normal vector 82. Furthermore, the image processing apparatus 50 may change the first virtual projection apparatus 112 superimposed on the physical space image 90 in accordance with a change in the first virtual projection surface 111 superimposed on the physical space image 90.

This allows the user to adjust the position and the angle of the first virtual projection surface 111, and visually ascertain the size and the disposition of the projection surface 11 in the desired projection state, and the positional relationship between the projection surface 11 and the projection apparatus 10.

### <Reception of Change Instruction of Lens Shift Amount>

For example, through the processing shown in FIG. 10, the image processing apparatus 50 may receive, from the user, an instruction to change the lens shift amount within a range that can be set for the model designated as the model of the first virtual projection apparatus 112 in the state in which the first virtual projection surface 111 and the first virtual projection apparatus 112 are displayed to be superimposed on the physical space image 90 as shown in FIG. 12 using the touch panel 51.

In a case in which an instruction to change the lens shift amount is received, the image processing apparatus 50 generates a first virtual projection apparatus 112 in the physical space image 90, the shape of which is adjusted such that it appears to be disposed at a position away from the center (first position 81) of the first virtual projection surface 111 in the direction of the first normal vector 82 by a first projection distance, and as if the changed lens shift amount is set, and displays the generated first virtual projection apparatus 112 to be superimposed on the physical space image 90.

In this way, the image processing apparatus 50 may change the first virtual projection apparatus 112 superimposed on the physical space image 90 based on second input data (for example, data based on an operation on the touch panel 51) regarding a change in the shift amount of the projection lens of the first virtual projection apparatus 112. This allows the user to visually ascertain the size and the disposition of the projection surface 11 when the lens shift amount is set in the projection apparatus 10, and the positional relationship between the projection surface 11 and the projection apparatus 10.

### <Imaging of First Image and Acquisition of First and Second Positions>

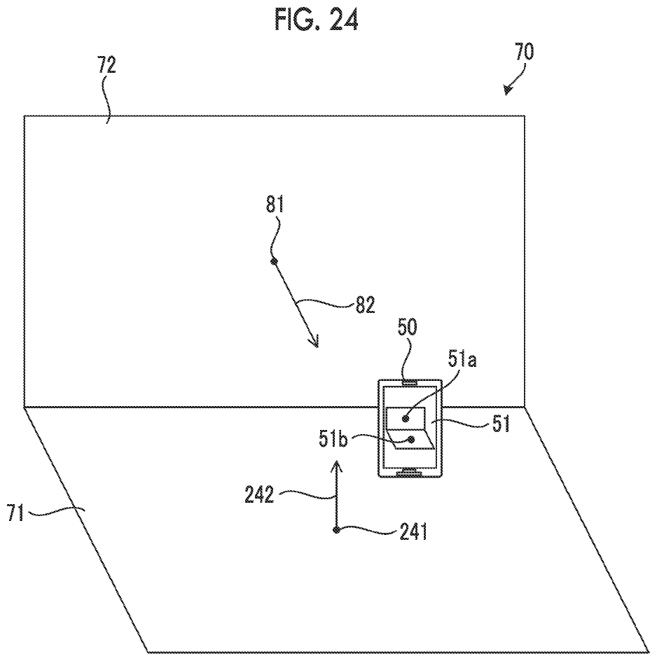

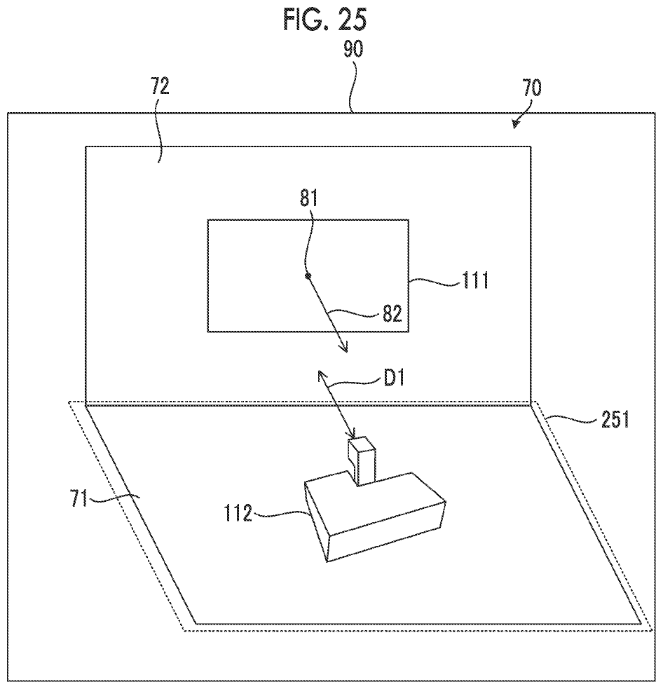

FIG. 24 is a diagram showing an example of imaging the first image and acquiring first and second positions. FIG. 25 is a diagram showing an example of a second virtual projection surface based on the second position. Although the case in which the first position 81 where the projection surface 11 is disposed is acquired has been described with reference to FIG. 8, the image processing apparatus 50 may further acquire a second position where the projection apparatus 10 is disposed.

Here, it is assumed that the user intends to set the first position 81 of the wall 72 as a position at which the projection surface 11 is disposed, and intends to set a second position 241 of the floor 71 as a position at which the projection apparatus 10 is disposed. In this case, as shown in FIG. 24, the user holds the image processing apparatus 50 at a position and an orientation at which the first position 81 and the second position 241 are displayed on the touch panel 51.

Then, the user gives an instruction for the first position 81 in the physical space 70 by performing an instruction operation (for example, tap operation) on the first position 81 (the position 51a of the touch panel 51) of the wall 72 displayed on the touch panel 51. Further, the user gives an instruction for the second position 241 in the physical space 70 by performing an instruction operation (for example, tap operation) on the second position 241 (a position 51b of the touch panel 51) of the floor 71 displayed on the touch panel 51. Accordingly, the image processing apparatus 50 can acquire first position data representing the first position 81 and second position data representing the second position 241 in the three-dimensional orthogonal coordinate system shown in FIG. 7.

A second normal vector 242 is a normal vector of a second surface corresponding to the floor 71, which is an object present at the second position 241 in the physical space 70, in the three-dimensional orthogonal coordinate system shown in FIG. 7. The image processing apparatus 50 acquires second normal vector data representing the second normal vector 242 based on the result of recognizing the physical space 70 with the space recognition sensor. This enables the image processing apparatus 50 to acquire first normal vector data representing the first normal vector 82 and second normal vector data representing the second normal vector 242.

Then, the image processing apparatus 50 executes the processing shown in FIG. 10. Here, in Step S105 shown in FIG. 10, the image processing apparatus 50 constructs a virtual plane 251 corresponding to the floor 71 as shown in FIG. 25 based on the second position data and the second normal vector data. Then, the image processing apparatus 50 generates a first virtual projection apparatus 112 in the physical space image 90, the shape of which is adjusted such that it appears to be disposed at a position away from the first virtual projection surface 111 in the direction of the first normal vector 82 by a first projection distance (distance D1), and with its bottom surface in contact with the virtual plane 251, and displays the generated first virtual projection apparatus 112 to be superimposed on the physical space image 90.

### <Coordinate Axes for Movement of First Virtual Projection Apparatus 112>

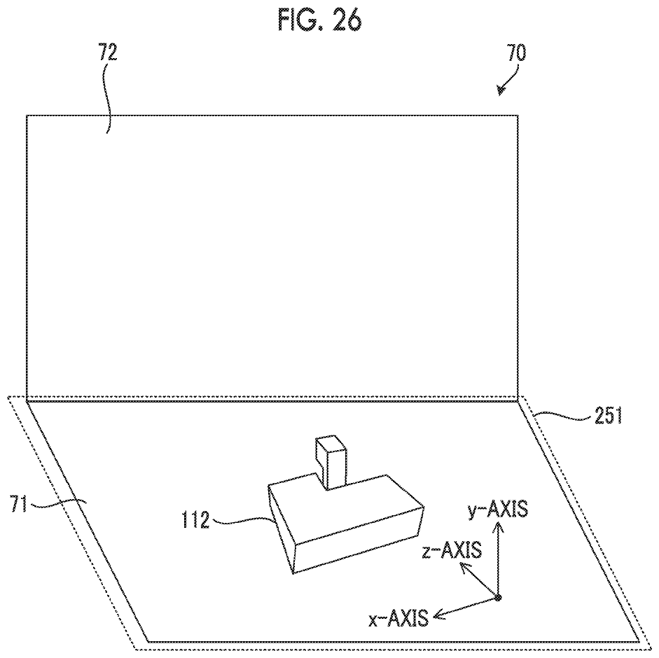

FIG. 26 is a diagram showing an example of coordinate axes for movement of the first virtual projection apparatus 112. Using the first virtual projection apparatus 112 as a reference, a three-dimensional orthogonal coordinate system is defined in which the axis perpendicular to the bottom surface (virtual plane 251) of the first virtual projection apparatus 112 is a y-axis, the left-right direction of the first virtual projection apparatus 112 is an x-axis, and the remaining axis (the front-rear direction of the first virtual projection apparatus 112) is a z-axis.

<Operation Unit for Moving First Virtual Projection Apparatus 112 in x-Axis Direction or z-Axis Direction>

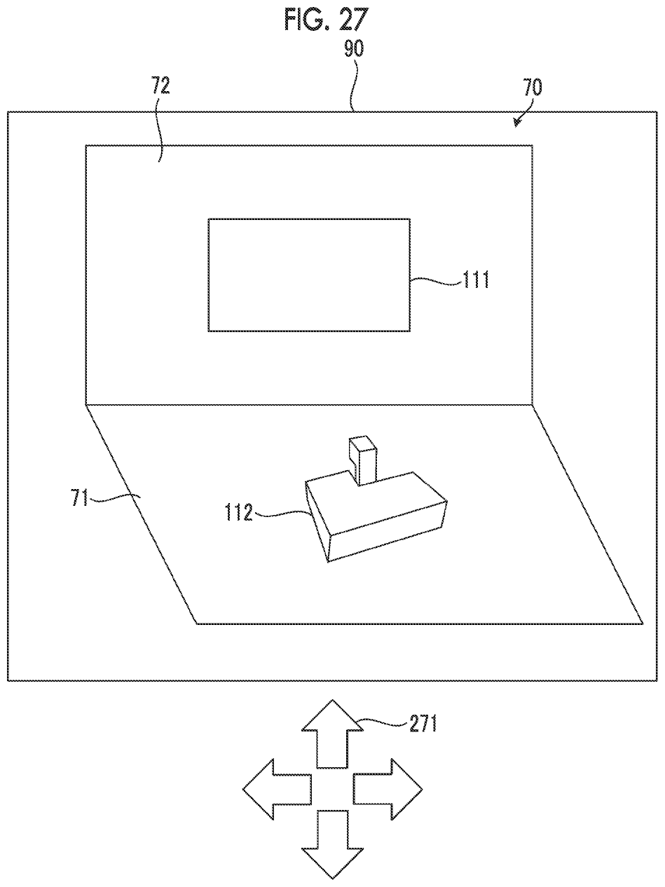

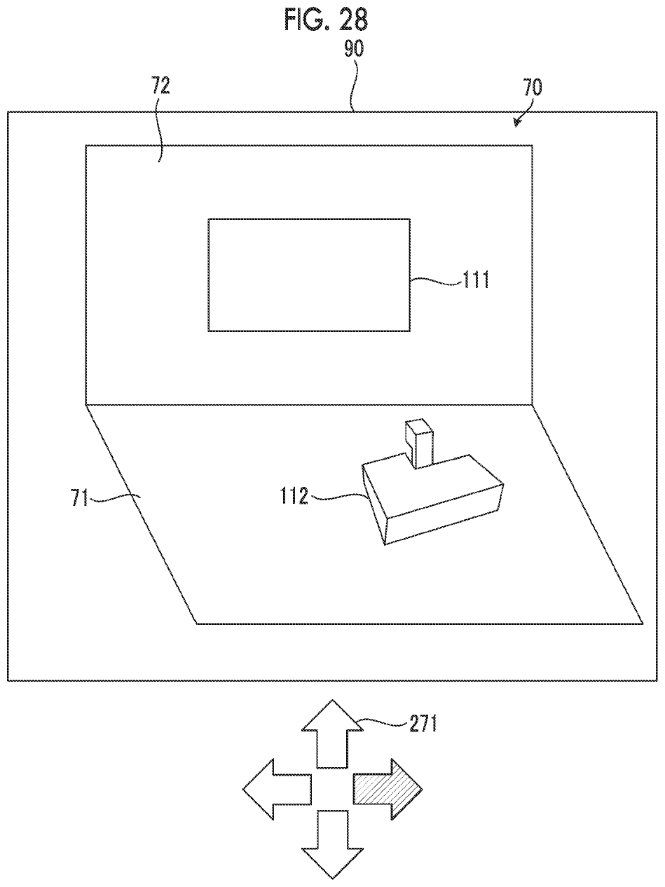

FIGS. 27 and 28 are diagrams showing an example of an operation unit for moving the first virtual projection apparatus 112 in the x-axis direction or the z-axis direction. For example, through the processing shown in FIG. 10, the image processing apparatus 50 may further display a first virtual projection apparatus operation unit 271 as shown in FIG. 27 in the state in which the first virtual projection surface 111 and the first virtual projection apparatus 112 are displayed to be superimposed on the physical space image 90 as shown in FIG. 12 using the touch panel 51.

In the examples of FIGS. 27 and 28, the first virtual projection apparatus operation unit 271 is an image of a cursor key for giving an instruction for moving the front, rear, left, and right, and a touch operation can be used to give an instruction to move the first virtual projection apparatus 112 forward, rearward, left, and right (z-axis and x-axis).

For example, as shown in FIG. 28, in a case in which a touch operation is performed on the right cursor key of the first virtual projection apparatus operation unit 271, the image processing apparatus 50 moves the superimposition position of the first virtual projection apparatus 112 relative to the physical space image 90 to the right.

Specifically, the image processing apparatus 50 generates a first virtual projection apparatus 112 in the physical space image 90, the shape of which is adjusted such that the first virtual projection apparatus 112 appears to be disposed at a position moved to the right from its original position, and displays the generated first virtual projection apparatus 112 to be superimposed on the physical space image 90.

Furthermore, in a case in which the first virtual projection apparatus 112 is moved in the z-axis direction, a first projection distance, which is the distance between the first virtual projection apparatus and the first virtual projection surface 111, changes. In response to this, the image processing apparatus 50 recalculates the size of the first virtual projection surface 111 based on the changed first projection distance, and displays the first virtual projection surface 111 of the recalculated size to be superimposed on the physical space image 90.

<Operation Unit for Moving First Virtual Projection Apparatus 112 in y-Axis Direction>

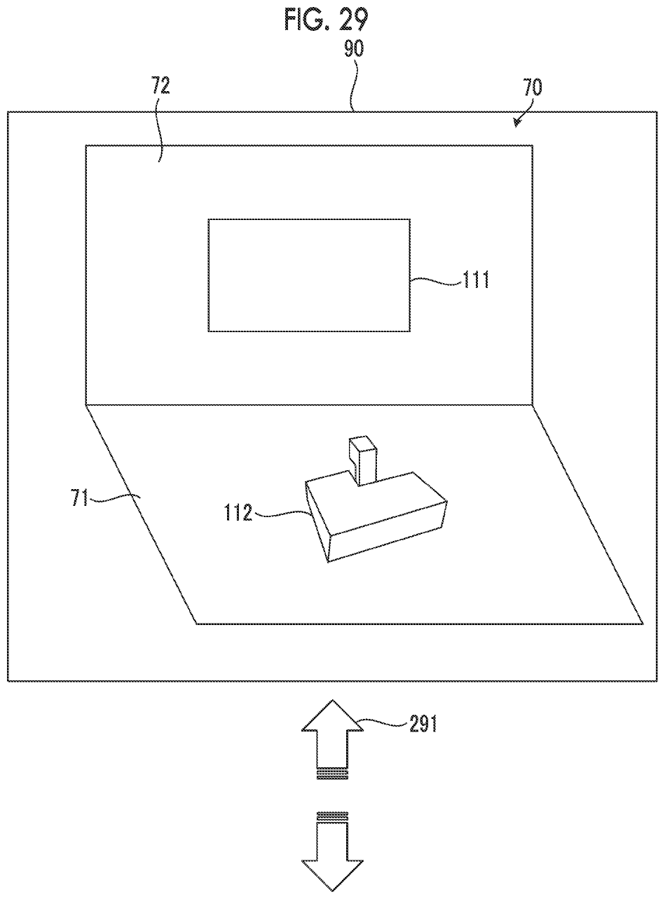

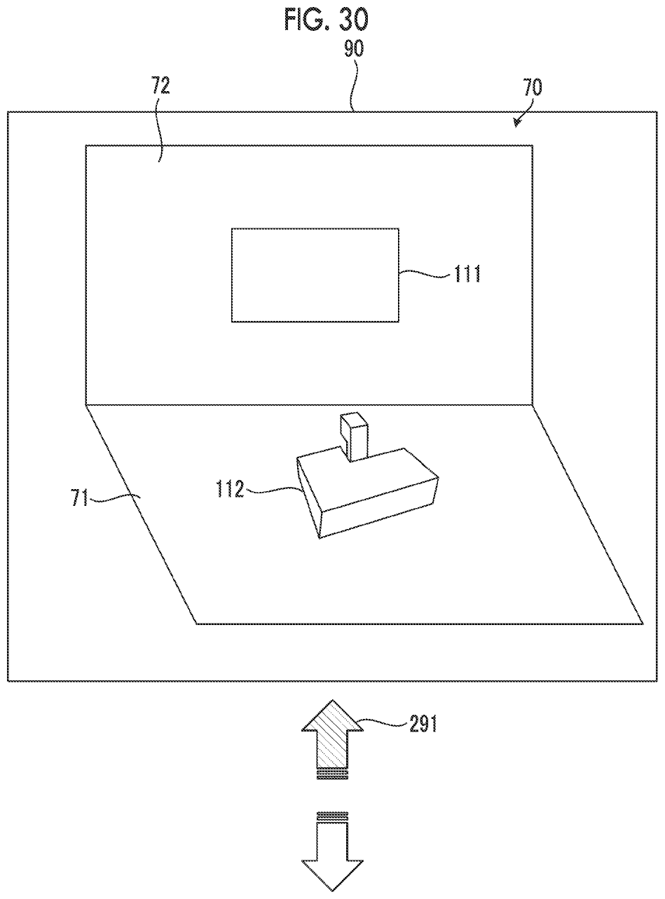

FIGS. 29 and 30 are diagrams showing an example of an operation unit for moving the first virtual projection apparatus 112 in a y-axis direction. For example, through the processing shown in FIG. 10, the image processing apparatus 50 may further display a first virtual projection apparatus operation unit 291 as shown in FIG. 29 in the state in which the first virtual projection surface 111 and the first virtual projection apparatus 112 are displayed to be superimposed on the physical space image 90 as shown in FIG. 12 using the touch panel 51.

In the examples of FIGS. 29 and 30, the first virtual projection apparatus operation unit 291 is an image of a cursor key for giving an instruction for moving the up and down, and a touch operation can be used to give an instruction to move the first virtual projection apparatus 112 up and down (in the y-axis direction).

For example, as shown in FIG. 30, in a case in which a touch operation is performed on the front cursor key of the first virtual projection apparatus operation unit 291, the image processing apparatus 50 moves the position of the first virtual projection apparatus 112 relative to the physical space image 90 upward.

Specifically, a first virtual projection apparatus 112 is generated in the physical space image 90, the shape of which is adjusted such that the first virtual projection apparatus 112 appears to be disposed at a position moved forward from its original position, and the generated first virtual projection apparatus 112 is displayed to be superimposed on the physical space image 90.

As shown in FIGS. 24 to 30, the image processing apparatus 50 may generate first virtual projection apparatus data based on first virtual projection surface data, second position data representing a second position 241 different from the first position 81 in the physical space 70, and second normal vector data representing a second normal vector 242 of the second surface corresponding to an object (floor 71) present at the second position 241 in the physical space 70.

### Embodiment 2

Embodiment 2 will be described with respect to the differences from Embodiment 1.

<Physical Curved Surface on which Projection Surface 11 is Disposed in Embodiment 2>

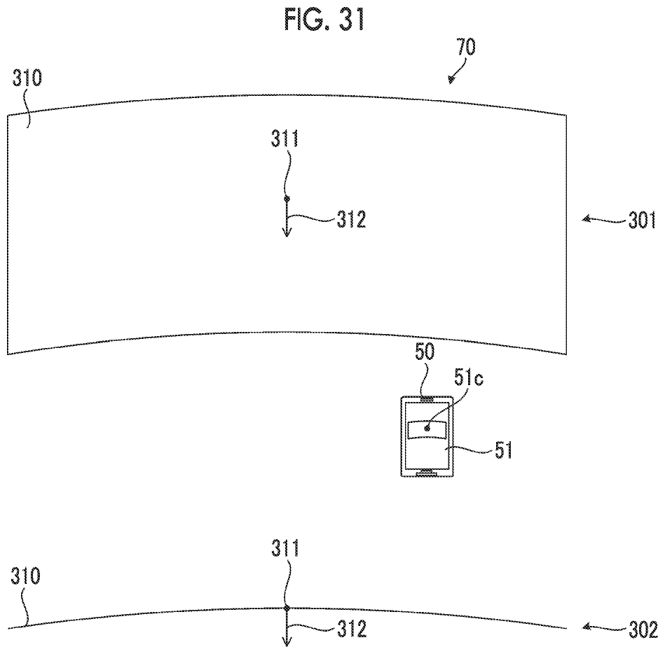

FIG. 31 is a diagram showing an example of a physical curved surface on which the projection surface 11 is disposed in Embodiment 2. An overhead view 301 and a top view 302 shown in FIG. 31 show an overhead view and a top view of a wall 310, which is a physical curved surface on which the projection surface 11 of the projection apparatus 10 is disposed. Here, it is assumed that a user intends to set a first position 311 near the center of the wall 310 as a position (center position) at which the projection surface 11 of the projection apparatus 10 is disposed. In this case, as shown in FIG. 31, the user holds the image processing apparatus 50 at a position and an orientation at which the first position 311 is displayed on the touch panel 51.

Then, the user gives an instruction for the first position 311 in the physical space 70 by performing an instruction operation (for example, tap operation) on the first position 311 (a position 51c of the touch panel 51) of the wall 310 displayed on the touch panel 51. Accordingly, the image processing apparatus 50 can acquire first position data representing the first position 311.

A first normal vector 312 is a normal vector corresponding to the first position 311 of a first surface corresponding to the wall 310, which is an object present at the first position 311 in the physical space 70. The image processing apparatus 50 acquires first normal vector data representing the first normal vector 312 based on the result of recognizing the physical space 70 with the space recognition sensor.

### <Designation of Second Position Group>

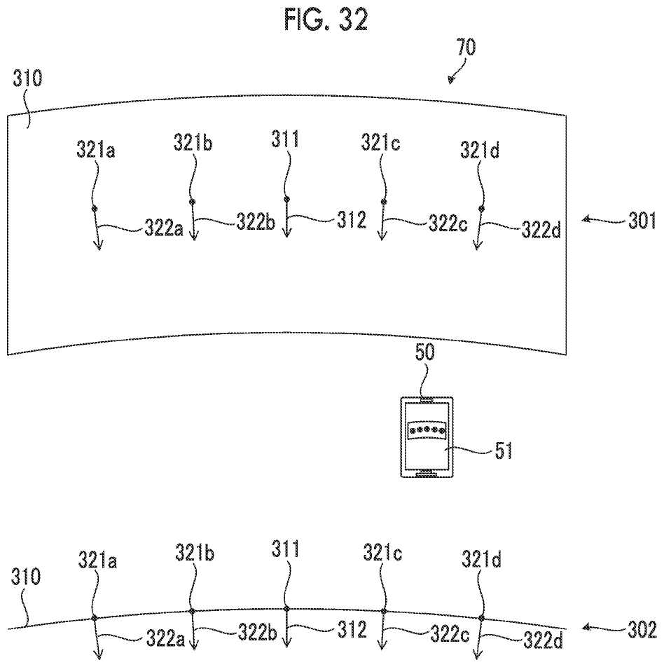

FIG. 32 is a diagram showing an example of designating a second position group. Furthermore, the image processing apparatus 50 receives, from the user, an instruction for a second position group sufficient to roughly reproduce the shape of the wall 310. The reception of the instruction for the second position group is performed in the same manner as the reception of the instruction for the first position 311 described with reference to FIG. 31.

In the example of FIG. 32, it is assumed that second positions 321a to 321d are designated as the second position group. Second normal vectors 322a to 322d are normal vectors of the first surface corresponding to the wall 310, which correspond to the second positions 321a to 321d, respectively. The image processing apparatus 50 acquires a group of second normal vector data representing the second normal vectors 322a to 322d based on the result of recognizing the physical space 70 with the space recognition sensor.

### <First Virtual Curved Surface Virtually Showing Wall 310>

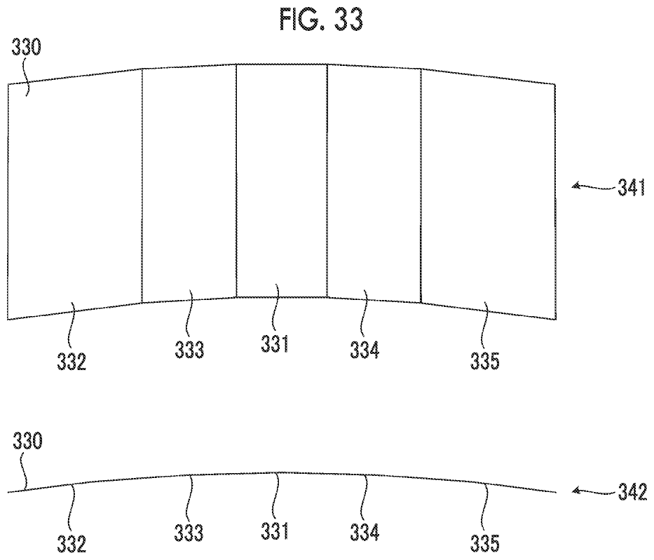

FIG. 33 is a diagram showing an example of a first virtual curved surface virtually showing the wall 310. The image processing apparatus 50 configures, for example, a first virtual curved surface 330 based on the first position 311, the first normal vector 312, the second positions 321a to 321d (second position group), and the second normal vectors 322a to 322d (second normal vector group). An overhead view 341 and a top view 342 shown in FIG. 33 show an overhead view and a top view of the first virtual curved surface 330.

The first virtual curved surface 330 is constructed as a pseudo-curved surface by disposing rectangular planes 331 to 335 adjacent to each other at different angles. The rectangular plane 331 is a plane based on the first position 311 and the first normal vector 312. The rectangular planes 332 to 335 are planes based on the second positions 321a to 321d and the second normal vectors 322a to 322d, respectively. Each of the rectangular planes 331 to 335 is formed by combining, for example, two triangular polygons.

Then, the image processing apparatus 50 executes the processing shown in FIG. 10. However, in Step S102 shown in FIG. 10, the image processing apparatus 50 generates a first virtual projection surface 111 in the physical space image 90, the first virtual projection surface 111 being centered on the first position 311, being perpendicular to the first normal vector 312, and having its shape adjusted such that it appears to be projected onto the first virtual curved surface 330 at a designated size, and displays the generated first virtual projection surface 111 to be superimposed on the physical space image 90.

Accordingly, by acquiring the first position data, the first normal vector data, second position group data, second normal vector group data, and physical space image 90 (first image) in the physical space 70, the user can visually ascertain the size and the disposition of the projection surface 11 based on the physical curved surface (wall 310) of the physical space 70, and the positional relationship between the projection surface 11 and the projection apparatus 10 on the physical space image 90 representing the physical space 70, even in places other than the physical space 70.

In addition, in a state in which the first virtual projection surface 111 and the first virtual projection apparatus 112 are displayed to be superimposed on the physical space image 90 based on the first virtual curved surface 330 using the touch panel 51, the image processing apparatus 50 may receive, from the user, an instruction to change the position or the angle of the first virtual projection surface 111, as in the examples of FIGS. 20 and 21, and update the first virtual projection surface 111 and the first virtual projection apparatus 112 superimposed on the physical space image 90 based on the received instruction.

In this way, the image processing apparatus 50 according to Embodiment 2 generates first virtual projection surface data and first virtual projection apparatus data based on first position data indicating the first position 311, first normal vector data indicating the first normal vector 312, second position group data representing the second position group (second positions 321a to 321d) on the first surface corresponding to the wall 310, and second normal vector group data representing the second normal vector group (second normal vectors 322a to 322d) corresponding to the second position group on the first surface corresponding to the wall 310.

Specifically, the image processing apparatus 50 generates virtual curved surface data representing the first virtual curved surface 330 based on the first position data, the first normal vector data, the second position group data, and the second normal vector group data, and generates first virtual projection surface data based on the first virtual projection apparatus data and the virtual curved surface data.

In addition, the image processing apparatus 50 may display, to the user, the position and the angle of the first virtual projection surface 111, the position and the angle of the first virtual projection apparatus 112, the first projection distance, projection parameters of the first virtual projection apparatus 112, and the like, in response to instructions from the user. At this time, the image processing apparatus 50 may determine the origin and the directions of the axes of the above-mentioned three-dimensional orthogonal coordinate system based on designation from the user. Accordingly, the user can ascertain the positional relationship between the projection surface and the projection apparatus visually checked and the projection parameters at that time as numerical values.

### MODIFICATION EXAMPLE

Modification examples related to each embodiment will be described.

### Modification Example 1

Although a case in which the image processing apparatus 50 is a tablet terminal having a touch panel 51 has been described, the image processing apparatus 50 is not limited to such a configuration. For example, the image processing apparatus 50 may be an information terminal, such as a smartphone or a personal computer.

### Modification Example 2

Although the configuration in which the image processing apparatus 50 displays the second image using the touch panel 51 has been described, the image processing apparatus 50 may transmit the generated second image to another apparatus to perform control to display the second image on the other apparatus. In this case, the image processing apparatus 50 may be an apparatus that does not comprise a display device.

### Modification Example 3

Although a case in which the physical space image 90 is an image obtained by imaging using an imaging apparatus of the image processing apparatus 50 has been described, the physical space image 90 may be an image obtained by imaging using an apparatus different from the image processing apparatus 50 and received by the image processing apparatus 50 from the apparatus. In this case, the image processing apparatus 50 may be an apparatus that does not comprise an imaging apparatus.

### (Image Processing Program)

The image processing method described in the above embodiment can be implemented by executing an image processing program prepared in advance on a computer. This image processing program is recorded in a computer-readable storage medium and is executed by being read from the storage medium by a computer. In addition, this image processing program may be provided in a form of being stored in a non-transitory storage medium, such as a flash memory, or may be provided via a network, such as the Internet. The computer that executes this image processing program may be included in an image processing apparatus, may be included in an electronic apparatus such as a smartphone, a tablet terminal, or a personal computer capable of communicating with the image processing apparatus, or may be included in a server apparatus capable of communicating with the image processing apparatus and the electronic apparatus.

The embodiments and the modification examples can be implemented in combination with each other.

At least the following matters are described in the present specification.

(1)

An image processing apparatus comprising a processor,
in which the processor is configured to:
   acquire first image data obtained by imaging a space with an imaging apparatus;
   generate first virtual projection surface data representing a first virtual projection surface and first virtual projection apparatus data representing a first virtual projection apparatus, based on first position data representing a first position in the space and first normal vector data representing a first normal vector of a first surface corresponding to an object present at the first position in the space;
   generate second image data representing a second image in which the first virtual projection surface and the first virtual projection apparatus are displayed on a first image represented by the first image data, based on the first image data, the first virtual projection surface data, and the first virtual projection apparatus data; and
   output the second image data to an output destination.
      (2)

The image processing apparatus according to (1),
in which the processor is configured to generate the first virtual projection apparatus data based on the first virtual projection surface data.
   (3)

The image processing apparatus according to (2),
in which the processor is configured to determine a normal vector of the first virtual projection surface in accordance with the first normal vector.
   (4)

The image processing apparatus according to (3),
in which the first virtual projection surface is a virtual projection surface having a normal vector that matches the first normal vector.
   (5)

The image processing apparatus according to any one of (2) to (4),
in which the processor is configured to determine a projection direction and a position of the first virtual projection apparatus based on a position and a size of the first virtual projection surface.
   (6)

The image processing apparatus according to any one of (1) to (5),
in which the processor is configured to determine the first normal vector data for the first position based on distance data related to a distance between the object and the imaging apparatus.
   (7)

The image processing apparatus according to any one of (1) to (6),
in which the processor is configured to specify a position of an end part of the first surface in the first image based on the first image data, and determine at least any of a position or a size of the first virtual projection surface based on the position of the end part.
   (8)

The image processing apparatus according to any one of (1) to (7),
in which the processor is configured to change the first virtual projection surface displayed in the second image based on first input data related to a change in at least any of the first position or the first normal vector.
   (9)

The image processing apparatus according to any one of (1) to (8),
in which the processor is configured to change the first virtual projection apparatus displayed in the second image based on second input data related to a change in a shift amount of a projection lens of the first virtual projection apparatus.
   (10)

The image processing apparatus according to any one of (1) to (9),
in which the processor is configured to generate the first virtual projection apparatus data based on the first virtual projection surface data, second position data representing a second position different from the first position in the space, and second normal vector data representing a second normal vector of a second surface corresponding to an object present at the second position in the space.
   (11)

The image processing apparatus according to (1),
in which the processor is configured to generate the first virtual projection surface data and the first virtual projection apparatus data based on the first position data, the first normal vector data, second position group data representing a second position group on the first surface, and second normal vector group data representing a second normal vector group corresponding to the second position group on the first surface.
   (12)

The image processing apparatus according to (11),
in which the processor is configured to:
   generate virtual curved surface data representing a virtual curved surface based on the first position data, the first normal vector data, the second position group data, and the second normal vector group data; and
   generate the first virtual projection surface data based on the first virtual projection apparatus data and the virtual curved surface data.
      (13)

An image processing method executed by a processor of an image processing apparatus, the image processing method comprising:
acquiring first image data obtained by imaging a space with an imaging apparatus;
generating first virtual projection surface data representing a first virtual projection surface and first virtual projection apparatus data representing a first virtual projection apparatus, based on first position data representing a first position in the space and first normal vector data representing a first normal vector of a first surface corresponding to an object present at the first position in the space;
generating second image data representing a second image in which the first virtual projection surface and the first virtual projection apparatus are displayed on a first image represented by the first image data, based on the first image data, the first virtual projection surface data, and the first virtual projection apparatus data; and
outputting the second image data to an output destination.
   (14)

An image processing program for causing a processor of an image processing apparatus to execute a process comprising:
acquiring first image data obtained by imaging a space with an imaging apparatus;
generating first virtual projection surface data representing a first virtual projection surface and first virtual projection apparatus data representing a first virtual projection apparatus, based on first position data representing a first position in the space and first normal vector data representing a first normal vector of a first surface corresponding to an object present at the first position in the space;
generating second image data representing a second image in which the first virtual projection surface and the first virtual projection apparatus are displayed on a first image represented by the first image data, based on the first image data, the first virtual projection surface data, and the first virtual projection apparatus data; and
outputting the second image data to an output destination.

Although various embodiments have been described above, it goes without saying that the present invention is not limited to these examples. It is apparent that those skilled in the art may perceive various modification examples or correction examples within the scope disclosed in the claims, and those examples are also understood as falling within the technical scope of the present invention. In addition, each constituent in the embodiment may be used in any combination without departing from the gist of the invention.

The present application is based on Japanese Patent Application (JP2022-057497) filed on Mar. 30, 2022, the content of which is incorporated in the present application by reference.

### EXPLANATION OF REFERENCES

1: projection portion
2: operation reception portion
2A, 3A: hollow portion
2a, 2b, 3a, 3c, 15a: opening
4: control device
4a, 62: memory
6: projection object
10: projection apparatus
11: projection surface
12: optical modulation unit
15: housing
21: light source
22: optical modulation portion
23: projection optical system
24: control circuit
31: second optical system
32, 122: reflective member
33: third optical system
34: lens
50: image processing apparatus
51: touch panel
51a, 51b, 51c: position
61: processor
63: communication interface
64: user interface
65: sensor
69: bus
70: physical space
71: floor
72, 73, 310: wall
72a to 72d: end part
81, 311: first position
82, 312: first normal vector
90: physical space image
101: body part
102: first member
103: second member
104: projection direction changing mechanism
105: shift mechanism
106: optical unit
111: first virtual projection surface
112: first virtual projection apparatus
121: first optical system
201, 221: first virtual projection surface operation unit
241, 321a to 321d: second position
242, 322a to 322d: second normal vector
251: virtual plane
271, 291: first virtual projection apparatus operation unit
330: first virtual curved surface
331 to 335: rectangular plane
G1: image
D1: distance

What is claimed is:

1. An image processing apparatus comprising a processor,
wherein the processor is configured to:
acquire first image data obtained by imaging a space with an imaging apparatus;
generate first virtual projection surface data representing a first virtual projection surface and first virtual projection apparatus data representing a first virtual projection apparatus, based on first position data representing a first position in the space and first normal vector data representing a first normal vector of a first surface corresponding to an object present at the first position in the space;
generate second image data representing a second image in which the first virtual projection surface and the first virtual projection apparatus are displayed on a first image represented by the first image data, based on the first image data, the first virtual projection surface data, and the first virtual projection apparatus data; and
output the second image data to an output destination.

2. The image processing apparatus according to claim 1,
wherein the processor is configured to generate the first virtual projection apparatus data based on the first virtual projection surface data.

3. The image processing apparatus according to claim 2,
wherein the processor is configured to determine a normal vector of the first virtual projection surface in accordance with the first normal vector.

4. The image processing apparatus according to claim 3,
wherein the first virtual projection surface is a virtual projection surface having a normal vector that matches the first normal vector.

5. The image processing apparatus according to claim 2,
wherein the processor is configured to determine a projection direction and a position of the first virtual projection apparatus based on a position and a size of the first virtual projection surface.

6. The image processing apparatus according to claim 1,
wherein the processor is configured to determine the first normal vector data for the first position based on distance data related to a distance between the object and the imaging apparatus.

7. The image processing apparatus according to claim 1,
wherein the processor is configured to specify a position of an end part of the first surface in the first image based on the first image data, and determine at least one of a position or a size of the first virtual projection surface based on the position of the end part.

8. The image processing apparatus according to claim 1,
wherein the processor is configured to change the first virtual projection surface displayed in the second image based on first input data related to a change in at least one of the first position or the first normal vector.

9. The image processing apparatus according to claim 1,
wherein the processor is configured to change the first virtual projection apparatus displayed in the second image based on second input data related to a change in a shift amount of a projection lens of the first virtual projection apparatus.

10. The image processing apparatus according to claim 1,
wherein the processor is configured to generate the first virtual projection apparatus data based on the first virtual projection surface data, second position data representing a second position different from the first position in the space, and second normal vector data representing a second normal vector of a second surface corresponding to an object present at the second position in the space.

11. The image processing apparatus according to claim 1,
wherein the processor is configured to generate the first virtual projection surface data and the first virtual projection apparatus data based on the first position data, the first normal vector data, second position group data representing a second position group on the first surface, and second normal vector group data representing a second normal vector group corresponding to the second position group on the first surface.

12. The image processing apparatus according to claim 11,
wherein the processor is configured to:
generate virtual curved surface data representing a virtual curved surface based on the first position data, the first normal vector data, the second position group data, and the second normal vector group data; and
generate the first virtual projection surface data based on the first virtual projection apparatus data and the virtual curved surface data.

13. An image processing method executed by a processor of an image processing apparatus, the image processing method comprising:
acquiring first image data obtained by imaging a space with an imaging apparatus;
generating first virtual projection surface data representing a first virtual projection surface and first virtual projection apparatus data representing a first virtual projection apparatus, based on first position data representing a first position in the space and first normal vector data representing a first normal vector of a first surface corresponding to an object present at the first position in the space;
generating second image data representing a second image in which the first virtual projection surface and the first virtual projection apparatus are displayed on a first image represented by the first image data, based on the first image data, the first virtual projection surface data, and the first virtual projection apparatus data; and
outputting the second image data to an output destination.

14. A non-transitory computer readable medium storing an image processing program for causing a processor of an image processing apparatus to execute a process comprising:
acquiring first image data obtained by imaging a space with an imaging apparatus;
generating first virtual projection surface data representing a first virtual projection surface and first virtual projection apparatus data representing a first virtual projection apparatus, based on first position data representing a first position in the space and first normal vector data representing a first normal vector of a first surface corresponding to an object present at the first position in the space;
generating second image data representing a second image in which the first virtual projection surface and the first virtual projection apparatus are displayed on a first image represented by the first image data, based on the first image data, the first virtual projection surface data, and the first virtual projection apparatus data; and
outputting the second image data to an output destination.
